(19) United States
(12) Patent Application Publication
(10) Pub. No.: US 2025/0067764 A1
(43) Pub. Date: Feb. 27, 2025

(54) DEVICE AND METHOD FOR ASPIRATING/DISPENSING OPERATION IN AUTOMATED ANALYZER

(71) Applicant: BECKMAN COULTER, INC., Brea, CA (US)

(72) Inventors: Matthew Weaver, Chaska, MN (US); Amit Sawhney, Chaska, MN (US); Mark A. Smith, Chaska, MN (US); Marie N. Willette, Chaska, MN (US); Ernesto F. Arita, Chaska, MN (US); Marcus Eidahl, Chaska, MN (US); Christopher A. Murray, Chaska, MN (US)

(21) Appl. No.: 18/723,520

(22) PCT Filed: Dec. 27, 2022
(86) PCT No.: PCT/IB2022/062803

§ 371 Date: Jun. 24, 2024

Related U.S. Application Data
(60) Provisional application No. 63/295,511, filed on Dec. 30, 2021.

(51) Int. Cl. G01N 35/10

(52) U.S. Cl. CPC G01N 35/1009; G01N 35/1016; G01N 2035/1018

(57) ABSTRACT

The present disclosure provides a computing device (100) for classification of an aspirating/dispensing operation in an automated analyzer (50). The computing device (100) comprises a memory (22) storing a neural network model (24). The neural network model 24 sequentially comprises a plurality of convolution blocks (202-1, 202-2 . . . 202-N). The computing device (100) further comprises a processor (20) communicably coupled to the memory (22) and at least one measurement sensor (106) associated with a pipetting probe (104) of a pipetting device (102). The processor (20) is capable of executing the neural network model (24). The processor (20) is further capable of executing instructions (26) to classify the aspirating/dispensing operation into at least one correct class or at least one incorrect class.

### FIELD

The present disclosure generally relates to aspirating/dispensing operations. Particularly, the present disclosure relates to a device and a method for an aspirating/dispensing operation in an automated analyzer.

### BACKGROUND

Clinical analyzers and/or immunoassays are well known in the art and are generally used for automated or semi-automated analysis of patient samples, such as blood, urine, spinal fluid, and the like. For testing and analyzing a patient sample, a specific component (i.e., an antigen) is measured in the patient sample. Analysis of the patient sample involve general procedures, such as aspirating the patient sample from a sample vessel, dispensing the patient sample into a reaction vessel, aspirating a reagent from a reagent pack, dispensing the reagent into the reaction vessel, and so on. All such procedures are conducted by using one or more probes. Finally, an amount of light is measured from a mixture of the patient sample and the reagent in the reaction vessel.

For all the aspirating and dispensing procedures, it is important that the patient sample and/or the reagent are aspirated and dispensed according to predetermined amounts. Any abnormal aspirating/dispensing operation may lead to an erroneous result of the analyzer. In some cases, bubbles are present on top of a sample liquid (i.e., the patient sample or the reagent). Generally, for aspirating the sample liquid, the probe is slightly immersed with its probe tip into the sample liquid to aspirate a given amount of the sample liquid. If the bubbles are present in the sample liquid during pipetting of the sample liquid, the probe may aspirate one or more bubbles and may not aspirate the sample liquid. Thus, the probe may aspirate only air and no sample liquid. In some cases, there may be one or more obstructions in the sample liquid or a tip of the probe. Presence of such obstructions may lead to an abnormal aspirating/dispensing operation. In some cases, hardware failures, such as an incorrect alignment of a pipetting device, an assembly error associated with the pipetting device, a pump failure, a tubing failure, a valve failure, or a user error involving improper loading of the sample liquid in a container, may also lead to abnormal aspirating/dispensing operations.

Any abnormal aspirating/dispensing operation may lead to incorrect analysis of the patient sample. The incorrect analysis of the patient sample may further lead to serious problems during the course of treatment of the patient. Moreover, if an abnormal aspirating/dispensing operation due to a faulty hardware is not detected, it may be difficult to identify a type of hardware failure that is causing the incorrect aspirating/dispensing operation. Consequently, undetected hardware failures may lead to subsequent abnormal aspirating/dispensing operations. In cases of an abnormal test result caused by an abnormal aspirating/dispensing operation, an operator may have to check various components of the analyzer to find out a real cause of the abnormal test result. This may increase a downtime of the analyzer and therefore reduce an overall efficiency of the analyzer. Therefore, it is important to detect and classify a type of error in the aspirating/dispensing operation. Common errors in the aspirating operation may comprise an empty aspiration (i.e., no aspirated liquid), an aspiration having an obstruction, and the like.

One of the conventional techniques for detecting the abnormal aspirating/dispensing operation involves pressure measurement in a flow passage of the probe during the aspirating/dispensing operation. One or more pressure sensors are disposed between a pump and the probe to measure/record pressure fluctuations in the flow passage. A pressure signal output is generated by the pressure fluctuations, and various signal processing and data acquisition methods are used to obtain and analyze the pressure signal output. The pressure signal output is typically an area under curve. Various fluctuations in the curve are analyzed to detect an abnormality in a corresponding aspirating/dispensing operation.

However, for detecting the abnormal aspirating/dispensing operation by pressure measurement technique (e.g., by area under the curve), the pressure sensors need to be calibrated and verified upon installation for various instruments. In some cases, there may be a need of an on-field calibration of the pressure sensors before the aspirating/dispensing operation. In such cases, it may be time consuming to calibrate the pressure sensors and set up the instrument. Moreover, there may be a user error associated with the calibration of pressure sensors, which may again falsely classify the aspirating/dispensing operation. Further, there is a lot of pipetting variability due to environment conditions (temperature and atmospheric pressure), sample/reagent type, and instrument assembly. Pipetting variability may also include variations in sensitivity of the pressure sensor, variations in an inner diameter of the probe, variations in a length of the flow passage, and the like. Thus, it may be difficult to accurately and reliably classify the aspirating/dispensing operation as normal or abnormal by using the pressure monitoring technique. Further, in case of any error during calibration of the pressure sensors for these variations, a normal aspirating/dispensing operation may be falsely detected as an abnormal aspirating/dispensing operation, and vice versa.

Moreover, during the calibration of the pressure sensors, an algorithm is used to define an upper limit and a lower limit of the area under the curve. The upper and lower limits may need to be updated every time there is any variation in a container, the probe, type of sample liquid/reagent, etc. Further, the algorithm takes into account initial aspirating/dispensing operations to define a baseline pressure (normal pressure) which may generate an erroneous test result if the initial aspirating/dispensing operations were abnormal.

In some cases, the conventional pressure measurement technique (e.g., by area under the curve) may be able to detect any abnormality in a gross aspirating/dispensing operation. However, as little variations in pressure signals can influence the area under the curve, the conventional techniques may not accurately detect the abnormality in a partial aspirating/dispensing operation. Further, for correctly classifying the aspirating/dispensing operation as normal or abnormal by the pressure measurement technique, a minimum volume of an aspirated/dispensed liquid is required.

### BRIEF SUMMARY

It is an object of the invention to improve the execution of an aspirating/dispensing operation in an automated analyzer, in particular to improve the accuracy of the analysis by minimizing/eliminating the risk of errors in the analysis of samples by the automated analyzer and to increase the efficiency of the automated analyzer.

The achievement of this object in accordance with the invention is set out in the independent claims. Further developments of the invention are the subject matter of the dependent claims.

According to a first aspect of the disclosure, an automated analyzer is provided. The automated analyzer is a device configured to automatically analyze a biological sample of a bodily fluid of a human or animal subject. For example, the bodily fluid may be a physiological fluid, such as blood, saliva, urine, sweat, amniotic fluid, cerebrospinal fluid, ascites fluid, or the like. The analysis may involve detecting the presence and/or concentration of one or more substances in the biological sample. For example, the automated analyzer may be an immunoassay analyzer or a clinical analyzer.

The automated analyzer comprises a pipetting device comprising a pipetting probe configured to conduct an aspirating/dispensing operation. The pipetting probe is capable of aspirating liquid, i.e. transferring a volume of liquid from the exterior of the pipetting probe to the interior of the pipetting probe, as well as of dispensing liquid, i.e. transferring a volume of liquid from the interior of the pipetting probe to the exterior of the pipetting probe. Accordingly, the pipetting probe is also capable of holding the volume liquid, e.g. after having aspirated it or before dispensing it. In particular, the pipetting probe may be configured to transfer sample liquid to/from a sample container (or “container”), such as a culture bottle, a vessel, or a test tube. The sample liquid to be aspirated/dispensed may be the biological sample, a reagent, a diluent or a mixture of any of these. The automated analyzer may further comprise a reservoir used to store a liquid to be dispensed. The pipetting device may comprise moving means, e.g. a robotic arm having one or more degrees of freedom, to move the pipetting probe.

The automated analyzer further comprises at least one measurement sensor associated with the pipetting probe. The at least one measurement sensor is configured to generate a sensor signal indicative of a fluid parameter in a flow passage of the pipetting probe. The automated analyzer may comprise a pump configured to apply a negative or positive pressure to cause the pipetting probe to aspirate or dispense the sample liquid. The pump may be connected to the pipetting probe by the flow passage, e.g. a hose. The at least one measurement sensor may comprise only one measurement sensor or a plurality of measurement sensors, e.g. an array of measurement sensors spaced apart from each other along the flow passage. In one example, the fluid parameter is the pressure in the flow passage and the at least one measurement sensor is a pressure sensor. In another example, the fluid parameter is the flow rate (e.g. volumetric flow rate) in the flow passage and the at least one measurement sensor is a flow sensor. The sensor signal may comprise a plurality of values indicative of the fluid parameter generated for a respective plurality of timepoints over an interval of time (e.g. sampled at a fixed rate), so that a development (e.g. a variation) of the fluid parameter over time can be determined. In other words, the sensor signal may comprise a vector of timely ordered fluid parameter values.

The automated analyzer further comprises a memory storing a neural network model. The neural network model sequentially comprises a plurality of convolution blocks, each of the plurality of convolution blocks comprising a first one-dimensional convolution layer and a second one-dimensional convolution layer. The plurality of convolution blocks may be sequentially arranged, wherein the input of a subsequent block that is arranged in the sequence after a preceding block is the output of the preceding block. A one-dimensional convolution layer comprises a plurality of filters/kernels, wherein each filter comprises a vector (or one-dimensional matrix) comprising a plurality of weights. Each filter is applied to a portion of the input of the one-dimensional convolution layer, more precisely a filter-sized portion of the input, i.e. a vector having the same number of elements as the number of weights. The filter and the filter-sized portion of the input are combined using the dot product, i.e. elementwise and summed providing a scalar value. The filter weights are adjusted during the training process to produce a larger value from an input portion comprising a particular sequence, which corresponds in effect to the feature the filter has learned to detect. The scalar product is computed for each filter-sized portion of the input, spanning the whole input. The scalar values are then stored in a one-dimensional matrix called a feature map. Larger values in the feature map represent where the learned feature was likely detected. Convolution layers are translation invariant, i.e. they detect whether a feature is present irrespective of where it is located. This process is repeated for each filter in the layer which allows a single layer to detect many features. Exemplarily, the neural network model may sequentially comprise an input layer, the plurality of convolution blocks, a flatten layer, and a probability layer.

The automated analyzer further comprises a processor communicably coupled to the at least one measurement sensor and the memory. The processor is capable of executing the neural network model. The neural network model is configured to classify, based on the sensor signal, the aspirating/dispensing operation in a class of a plurality of classes, the plurality of classes comprising at least one correct class and at least one incorrect class, specifically comprising at one correct class and at least one incorrect class. The sensor signal may constitute the input of the neural network model. It may be received as it was output from the at least one measurement sensor or may be received after a pre-processing step. Exemplarily, the input layer of the neural network model may be configured to receive the sensor signal and the probability layer may be configured to provide the probability values that classify the aspirating/dispensing operation.

Generally, an aspirating/dispensing operation is conducted with the aim of aspirating/dispensing a predetermined amount of liquid, e.g. of a patient sample and/or a reagent, without introducing any alterations, for example to the properties of the liquid (e.g. contamination) and/or to components of the automated analyzer, that could affect the result of the analysis. A “correct” (or “normal”) aspirating/dispensing operation is an operation that achieves its aim, namely an operation that leads to the predetermined amount of liquid being aspirated/dispensed without alterations. A correct aspirating/dispensing operation may be characterized by a specific (first) development of the fluid parameter over time. An “incorrect” (or “abnormal”) aspirating/dispensing operation is an operation that does not achieve its aim, namely an operation that fails to aspirate/dispense the predetermined amount of liquid and/or that erroneously introduces unwanted alterations. An incorrect aspirating/dispensing operation may be characterized by a specific (second) development of the fluid parameter over time, the second development being different from the first development.

A correct class indicates that the aspirating/dispensing operation is correct, while an incorrect class indicates that the aspirating/dispensing operation is incorrect. In other words, the neural network model is configured to classify the aspirating/dispensing operation as a correct aspirating/dispensing operation or as an incorrect aspirating/dispensing operation.

In a particular example, there may be a plurality of incorrect classes, each incorrect class being associated with a different type of incorrectness of the aspirating/dispensing operation. For instance, the plurality of classes may comprise a first incorrect class indicating an obstructed aspirating/dispensing operation and a second incorrect class indicating an empty aspirating/dispensing operation. Thus, the neural network model may be configured to classify the aspirating/dispensing operation as a correct aspirating/dispensing operation, as an aspirating/dispensing operation that is incorrect because an obstruction is present, e.g. in the pipetting probe and/or in the liquid to be aspirated/dispensed, or as an aspirating/dispensing operation that is incorrect because no liquid is being aspirated/dispensed. Pinpointing the reason of the failure/incorrectness of the aspirating/dispensing operation is advantageous in that appropriate steps can then be taken to address the cause and avoid further incorrect aspirating/dispensing operations.

As described above, the neural network model comprises a sequence of plural convolution blocks, wherein each convolution block comprises two one-dimensional convolution layers. This structure of the neural network model leads to a more accurate classification of the aspirating/dispensing operation, while at the same time improving the computational efficiency. A greater accuracy and efficiency of the classification of the aspirating/dispensing operation translates into a greater accuracy and efficiency of the automated analyzer, since errors in the analysis and a downtime of the automated analyzer can be avoided/minimized.

Furthermore, this structure of the neural network model allows for classification of aspirating/dispensing operation involving small volumes of sample liquid, e.g. volumes equal to or greater than 13 microliters, or volumes equal to or greater than 25 microliters, or volumes equal to or greater than 40 microliters.

The neural network model may comprise only one dense layer, the probability layer, and this makes the neural network model smaller and faster, i.e. more efficient timewise.

As the classification of the aspirating/dispensing operation is based on the neural network model comprising a sequence of plural convolution blocks, wherein each convolution block comprises two one-dimensional convolution layers, there may be no need for calibration of the at least one measurement sensor for variations, such as sample/reagent type, environment conditions (temperature and atmospheric pressure), instrument assembly, length of the flow passage, inner diameter of the pipetting probe, and the like. Accordingly, the at least one measurement sensor may be an uncalibrated sensor. An uncalibrated sensor is a sensor that outputs values for the fluid parameter that may be different from the actual values.

In contrast to conventional techniques that require the calibration of the at least one measurement sensor, no calibration of the at least one measurement sensor may be necessary. Therefore, a time that is utilized for the calibration in the conventional techniques may be saved in a testing process conducted by the automated analyzer of the present disclosure. Moreover, any user error associated with the calibration process in the conventional techniques may not affect the classification in the automated analyzer discussed herein. Therefore, a further improvement of the reliability and efficiency of classification of the aspirating/dispensing operation in the automated analyzer is achieved.

In a particular example, the neural network model may classify the aspirating/dispensing operation based only on the sensor signal. In other words, the neural network model may require only the sensor signal as input. For instance, the neural network model may not need input describing a configuration of the automated analyzer (e.g. features and/or settings of the pipetting probe) nor input describing characteristics of the sample liquid. This makes the neural network model smaller and faster, i.e. more efficient timewise.

In a particular example, the neural network model may further comprise an input layer and a noise layer between the input layer and a first convolution block of the plurality of convolution blocks. The noise layer may be configured to add noise (e.g. Gaussian noise) to the input of the neural network model, e.g. the sensor signal. The noise layer may be only active when the neural network model is trained, and may be inactive when used for classification in the automated analyzer. The addition of noise makes the neural network model more robust in detecting relative patterns instead of relying on absolute values. Thus, a neural network model comprising a noise layer may be even further suitable for making a classification on the basis of a sensor signal coming from an uncalibrated sensor.

In a particular example, the processor may be further capable of executing instructions to generate a flag upon classification of the aspirating/dispensing operation in an incorrect class. In this way, preventive measures can be taken, e.g. to prevent a further incorrect aspirating/dispensing operation from being conducted. For instance, upon classification of the aspirating/dispensing operation as incorrect, an operator may check for any hardware failure, such as pump failure, a tubing failure, a valve failure, a probe failure, and the like. The operator can identify one or more hardware failures responsible for an incorrect aspirating/dispensing operation and rectify them accordingly. This may increase an uptime of the automated analyzer and therefore increase an overall efficiency of the automated analyzer.

In a particular example, the neural network model may be configured to receive, e.g. via the input layer, the sensor signal as the aspirating/dispensing operation occurs. The sensor signal may be received while the aspirating/dispensing operation is still being conducted and it is not yet completed or as soon as the aspirating/dispensing operation is completed. The latency between the generation of the sensor signal and the provision of the sensor signal to the neural network model may be only due to the time required for data transmission, so that the sensor signal may be received “in real time”. The aspirating/dispensing operation may be considered as part of the more general analysis process carried out by the automated analyzer to analyze the biological sample. If the sensor signal is received as the aspirating/dispensing operation occurs, remedial measures can be taken, as the automated analyzer may otherwise provide erroneous results when analyzing the biological sample subsequent to the incorrect aspirating/dispensing operation. The remedial measures may include stopping or disallowing the ongoing process of analysis of the biological sample. For instance, the automated analyzer may be configured to automatically stop an analysis process upon generation of the flag. In particular, the processor may be further capable of executing instructions to stop an analysis process upon generation of the flag. In another instance, an operator may stop the analysis process. In this way, resources and time that would be wasted to complete the analysis process leading to an erroneous result can be saved. Additionally or alternatively, the remedial measures may include conducting another aspirating/dispensing operation, i.e. a second aspirating/dispensing operation after the incorrect (first) aspirating/dispensing operation. The second aspirating/dispensing operation may be carried out after the cause of the incorrect first aspirating/dispensing operation is addressed.

It should be noted that while the classification may be performed “on-the-fly”, the training of the neural network model is performed beforehand and not “on-the-fly”. In other words, the parameters of the neural network model are fixed before the neural network model is stored in the memory of the automated analyzer. In this way, no expensive hardware needed for training is required at the automated analyzer. Furthermore, the neural network model may be certified by regulatory bodies.

In a particular example, each of the plurality of convolution blocks may sequentially comprise the first one-dimensional convolution layer, a first batch normalization layer, a first activation layer, the second one-dimensional convolution layer, a second batch normalization layer, a second activation layer, and a pooling layer. The activation function used in the activation layers may be the swish function, which leads to a greater accuracy and makes the training process faster.

In a further particular example, the processor may be further capable of executing instructions to generate, via each of the plurality of convolution blocks, a corresponding block output. For generating the corresponding block output, the processor may be further capable of executing instructions to determine a first feature map by applying the first one-dimensional convolution layer on the sensor signal received from the input layer or the corresponding block output received from a previous convolution block from the plurality of convolution blocks. For generating the corresponding block output, the processor may be further capable of executing instructions to generate, via the first batch normalization layer, a first normalized feature map by normalizing the first feature map received from the first one-dimensional convolution layer. For generating the corresponding block output, the processor may be further capable of executing instructions to generate, via the first activation layer, a first activated feature map by selecting a set of first features from the first normalized feature map received from the first batch normalization layer. For generating the corresponding block output, the processor may be further capable of executing instructions to determine a second feature map by applying the second one-dimensional convolution layer on the first activated feature map received from the first activation layer. For generating the corresponding block output, the processor may be further capable of executing instructions to generate, via the second batch normalization layer, a second normalized feature map by normalizing the second feature map received from the second one-dimensional convolution layer. For generating the corresponding block output, the processor may be further capable of executing instructions to generate, via the second activation layer, a second activated feature map by selecting a set of second features from the second normalized feature map received from the second batch normalization layer. For generating the corresponding block output, the processor may be further capable of executing instructions to generate, via the pooling layer, the corresponding block output by reducing a spatial size of the second activated feature map received from the second activation layer. The processor may be further capable of executing instructions to generate, via the flatten layer, a one-dimensional vector output by converting the corresponding block output received from the previous convolution block. The processor may be further capable of executing instructions to classify, via the probability layer, the aspirating/dispensing operation into the at least one correct class or the at least one incorrect class by using the one-dimensional vector output received from the flatten layer, specifically the aspirating/dispensing operation into the one correct class or the at least one incorrect class by using the one-dimensional vector output received from the flatten layer.

In a particular example, the first one-dimensional convolution layer of each of the plurality of convolution blocks may comprise a plurality of first parameters. The second one-dimensional convolution layer of each of the plurality of convolution blocks may comprise a plurality of second parameters. A number of the plurality of second parameters may be greater than or equal to a number of the plurality of first parameters.

In a particular example, the plurality of convolution blocks sequentially may comprise a first convolution block receiving the sensor signal from the input layer, one or more intermediate convolution blocks, and a last convolution block providing the corresponding block output to the flatten layer.

In a particular example, for the first convolution block, the number of the plurality of second parameters may be greater than the number of the plurality of first parameters by a factor of at least 50.

In a particular example, for each of the one or more intermediate convolution blocks, the number of the plurality of second parameters may be equal to the number of the plurality of first parameters.

In a particular example, for the last convolution block, the number of the plurality of second parameters may be equal to the number of the plurality of first parameters.

In a particular example, the sensor signal may be a voltage signal.

In a particular example, the processor may be further capable of executing instructions to generate training data for training the neural network model. For generating the training data, the processor may be further capable of executing instructions to collect prior data associated with a plurality of aspirating/dispensing operations. For generating the training data, the processor may be further capable of executing instructions to label the prior data with a plurality of classifications to generate labelled data. Each of the plurality of classifications is associated with a corresponding aspirating/dispensing operation from the plurality of aspirating/dispensing operations. Each of the plurality of classifications is one of a correct aspirating/dispensing operation and an incorrect aspirating/dispensing operation. For generating the training data, the processor may be further capable of executing instructions to filter the labelled data to generate filtered data. For generating the training data, the processor may be further capable of executing instructions to normalize the filtered data based on one or more parameters to generate the training data.

In a particular example, for filtering the labelled data, the processor may be further capable of executing instructions to remove a portion of the labelled data that is not associated with a pipetting probe. For filtering the labelled data, the processor may be further capable of executing instructions to remove a portion of the labelled data that is simulated. For filtering the labelled data, the processor may be further capable of executing instructions to remove a portion of the labelled data that is not associated with a reagent in an aspirating/dispensing operation.

In a particular example, for filtering the labelled data, the processor may be further capable of executing instructions to remove a portion of the labelled data labelled as correct for which a value of the sensor signal is not changing with time. For filtering the labelled data, the processor may be further capable of executing instructions to remove a portion of the labelled data labelled as correct for which the value of the sensor signal crosses one of an upper signal value and a lower signal value.

According to a second aspect of the disclosure, a method of classification of an aspirating/dispensing operation in an automated analyzer comprising a pipetting probe is provided. The method comprises generating, by at least one measurement sensor, a sensor signal indicative of a fluid parameter in a flow passage of the pipetting probe used in the aspirating/dispensing operation. The method further comprises providing a neural network model comprising a plurality of convolution blocks, wherein each of the plurality of convolution blocks comprises a first one-dimensional convolution layer and a second one-dimensional convolution layer. The plurality of convolution blocks may be sequentially arranged, wherein the input of a subsequent block that is arranged in the sequence after a preceding block is the output of the preceding block. The method further comprises classifying, via the neural network model and based on the sensor signal, the aspirating/dispensing operation into a class of a plurality of classes comprising at least one correct class and at least one incorrect class.

In a particular example, the neural network model may sequentially comprise an input layer, the plurality of convolution blocks, a flatten layer, and a probability layer.

In a particular example, the incorrect class may comprise a first subclass indicating an obstructed aspirating/dispensing operation and a second subclass indicating an empty aspirating/dispensing operation.

In a particular example, the at least one measurement sensor may be an uncalibrated sensor.

In a particular example, the classifying of the aspirating/dispensing operation may be based only on the sensor signal.

In a particular example, the neural network model may further comprise an input layer and a noise layer between the input layer and a first convolution block of the plurality of convolution blocks and the method may further comprise training the neural network model (24), wherein training the neural network model (24) comprises activating the noise layer.

In a particular example, the method may further comprise generating a flag upon classification of the aspirating/dispensing operation in the at least one incorrect class.

In a further particular example, the method may further comprise stopping an analysis process upon generation of the flag.

In a particular example, the at least one measurement sensor may be a pressure sensor, and the flow parameter may be pressure.

In a particular example, the sensor signal may be received by the neural network model as the aspirating/dispensing operation occurs.

In a particular example, each of the plurality of convolution blocks may sequentially comprise the first one-dimensional convolution layer, a first batch normalization layer, a first activation layer, the second one-dimensional convolution layer, a second batch normalization layer, a second activation layer, and a pooling layer.

In a further particular example, the method may further comprise generating, via each of the plurality of convolution blocks, a corresponding block output. Generating the corresponding block output may further comprise determining a first feature map by applying the first one-dimensional convolution layer on the sensor signal received from the input layer or the corresponding block output received from a previous convolution block from the plurality of convolution blocks. Generating the corresponding block output may further comprise generating, via the first batch normalization layer, a first normalized feature map by normalizing the first feature map received from the first one-dimensional convolution layer. Generating the corresponding block output may further comprise generating, via the first activation layer, a first activated feature map by selecting a set of first features from the first normalized feature map received from the first batch normalization layer. Generating the corresponding block output may further comprise determining a second feature map by applying the second one-dimensional convolution layer on the first activated feature map received from the first activation layer. Generating the corresponding block output may further comprise generating, via the second batch normalization layer, a second normalized feature map by normalizing the second feature map received from the second one-dimensional convolution layer. Generating the corresponding block output may further comprise generating, via the second activation layer, a second activated feature map by selecting a set of second features from the second normalized feature map received from the second batch normalization layer. Generating the corresponding block output may further comprise generating, via the pooling layer, the corresponding block output by reducing a spatial size of the second activated feature map received from the second activation layer. The method may further comprise generating, via the flatten layer, a one-dimensional vector output by converting the corresponding block output received from the previous convolution block. The method may further comprise classifying, via the probability layer, the aspirating/dispensing operation into the at least one correct class or into the at least one incorrect class by using the one-dimensional vector output received from the flatten layer, specifically the aspirating/dispensing operation into the one correct class or into the at least one incorrect class by using the one-dimensional vector output received from the flatten layer.

In a particular example, the first one-dimensional convolution layer of each of the plurality of convolution blocks may comprise a plurality of first parameters. The second one-dimensional convolution layer of each of the plurality of convolution blocks may comprise a plurality of second parameters. A number of the plurality of second parameters may be greater than or equal to a number of the plurality of first parameters.

In a particular example, the plurality of convolution blocks may sequentially comprise a first convolution block receiving the sensor signal from the input layer, one or more intermediate convolution blocks, and a last convolution block providing the corresponding block output to the flatten layer.

In a particular example, for the first convolution block, the number of the plurality of second parameters may be greater than the number of the plurality of first parameters by a factor of at least 50.

In a particular example, for each of the one or more intermediate convolution blocks, the number of the plurality of second parameters may be equal to the number of the plurality of first parameters.

In a particular example, for the last convolution block, the number of the plurality of second parameters may be equal to the number of the plurality of first parameters.

In a particular example, the sensor signal may be a voltage signal.

In a particular example, the method may further comprise generating training data for training the neural network model. Generating the training data may comprise collecting prior data associated with a plurality of aspirating/dispensing operations. Generating the training data may further comprise labelling the prior data with a plurality of classifications to generate labelled data. Each of the plurality of classifications is associated with a corresponding aspirating/dispensing operation from the plurality of aspirating/dispensing operations. Each of the plurality of classifications is one of a correct aspirating/dispensing operation and an incorrect aspirating/dispensing operation. Generating the training data may further comprise filtering the labelled data to generate filtered data. Generating the training data may further comprise normalizing the filtered data based on one or more parameters to generate the training data.

In a particular example, filtering the labelled data further may comprise removing a portion of the labelled data that is not associated with a pipetting probe. Filtering the labelled data may further comprise removing a portion of the labelled data that is simulated. Filtering the labelled data may further comprise removing a portion of the labelled data that is not associated with a reagent in an aspirating/dispensing operation.

In a particular example, filtering the labelled data may further comprise removing a portion of the labelled data labelled as correct for which a value of the sensor signal is not changing with time. Filtering the labelled data may further comprise removing a portion of the labelled data labelled as correct for which the value of the sensor signal crosses one of an upper signal value and a lower signal value.

According to a third aspect of the disclosure, a computing device for classification of an aspirating/dispensing operation in an automated analyzer is provided. The computing device comprises a memory storing a neural network model. The neural network model comprises a plurality of convolution blocks, each of the plurality of convolution blocks comprising a first one-dimensional convolution layer and a second one-dimensional convolution layer. The plurality of convolution blocks may be sequentially arranged, wherein the input of a subsequent block that is arranged in the sequence after a preceding block is the output of the preceding block. The computing device further comprises a processor communicably coupled to the memory and at least one measurement sensor associated with a pipetting probe of the automated analyzer. The processor is capable of executing the neural network model. The neural network model is configured to classify, based on a sensor signal generated by the at least one measurement sensor, the aspirating/dispensing operation into a class of a plurality of classes comprising at least one correct class and at least one incorrect class. In particular, the sensor signal may be indicative of a fluid parameter in a flow passage of the pipetting probe.

In a particular example, the neural network model may sequentially comprise an input layer, the plurality of convolution blocks, a flatten layer, and a probability layer.

In a particular example, the plurality of classes may comprise a first incorrect class indicating an obstructed aspirating/dispensing operation and a second incorrect class indicating an empty aspirating/dispensing operation.

In a particular example, the classification may be based only on the sensor signal.

In a particular example, the neural network model may further comprise an input layer and a noise layer between the input layer and a first convolution block of the plurality of convolution blocks.

In a particular example, the processor may be further capable of executing instructions to generate a flag upon classification of the aspirating/dispensing operation in an incorrect class.

In a further particular example, the processor may be further capable of executing instructions to stop an analysis process upon generation of the flag.

In a particular example, the neural network model may be configured to receive, e.g. via the input layer, the sensor signal as the aspirating/dispensing operation occurs.

In a particular example, each of the plurality of convolution blocks may sequentially comprise the first one-dimensional convolution layer, a first batch normalization layer, a first activation layer, the second one-dimensional convolution layer, a second batch normalization layer, a second activation layer, and a pooling layer.

In a further particular example, the processor may be further capable of executing instructions to generate, via each of the plurality of convolution blocks, a corresponding block output. For generating the corresponding block output, the processor may be further capable of executing instructions to determine a first feature map by applying the first one-dimensional convolution layer on the sensor signal received from the input layer or the corresponding block output received from a previous convolution block from the plurality of convolution blocks. For generating the corresponding block output, the processor may be further capable of executing instructions to generate, via the first batch normalization layer, a first normalized feature map by normalizing the first feature map received from the first one-dimensional convolution layer. For generating the corresponding block output, the processor may be further capable of executing instructions to generate, via the first activation layer, a first activated feature map by selecting a set of first features from the first normalized feature map received from the first batch normalization layer. For generating the corresponding block output, the processor may be further capable of executing instructions to determine a second feature map by applying the second one-dimensional convolution layer on the first activated feature map received from the first activation layer. For generating the corresponding block output, the processor may be further capable of executing instructions to generate, via the second batch normalization layer, a second normalized feature map by normalizing the second feature map received from the second one-dimensional convolution layer. For generating the corresponding block output, the processor may be further capable of executing instructions to generate, via the second activation layer, a second activated feature map by selecting a set of second features from the second normalized feature map received from the second batch normalization layer. For generating the corresponding block output, the processor may be further capable of executing instructions to generate, via the pooling layer, the corresponding block output by reducing a spatial size of the second activated feature map received from the second activation layer. The processor may be further capable of executing instructions to generate, via the flatten layer, a one-dimensional vector output by converting the corresponding block output received from the previous convolution block. The processor may be further capable of executing instructions to classify, via the probability layer, the aspirating/dispensing operation into the at least one correct class or the at least one incorrect class by using the one-dimensional vector output received from the flatten layer.

In a particular example, the first one-dimensional convolution layer of each of the plurality of convolution blocks may comprise a plurality of first parameters. The second one-dimensional convolution layer of each of the plurality of convolution blocks may comprise a plurality of second parameters. A number of the plurality of second parameters may be greater than or equal to a number of the plurality of first parameters.

In a particular example, the plurality of convolution blocks sequentially may comprise a first convolution block receiving the sensor signal from the input layer, one or more intermediate convolution blocks, and a last convolution block providing the corresponding block output to the flatten layer.

In a particular example, for the first convolution block, the number of the plurality of second parameters may be greater than the number of the plurality of first parameters by a factor of at least 50.

In a particular example, for each of the one or more intermediate convolution blocks, the number of the plurality of second parameters may be equal to the number of the plurality of first parameters.

In a particular example, for the last convolution block, the number of the plurality of second parameters may be equal to the number of the plurality of first parameters.

In a particular example, the at least one measurement sensor may be a pressure sensor, and the flow parameter may be pressure.

In a particular example, the sensor signal is a voltage signal.

In a particular example, the processor may be further capable of executing instructions to generate training data for training the neural network model. For generating the training data, the processor may be further capable of executing instructions to collect prior data associated with a plurality of aspirating/dispensing operations. For generating the training data, the processor may be further capable of executing instructions to label the prior data with a plurality of classifications to generate labelled data. Each of the plurality of classifications is associated with a corresponding aspirating/dispensing operation from the plurality of aspirating/dispensing operations. Each of the plurality of classifications is one of correct aspirating/dispensing operation and incorrect aspirating/dispensing operation. For generating the training data, the processor may be further capable of executing instructions to filter the labelled data to generate filtered data. For generating the training data, the processor may be further capable of executing instructions to normalize the filtered data based on one or more parameters to generate the training data.

In a particular example, for filtering the labelled data, the processor may be further capable of executing instructions to remove a portion of the labelled data that is not associated with a pipetting probe. For filtering the labelled data, the processor may be further capable of executing instructions to remove a portion of the labelled data that is simulated. For filtering the labelled data, the processor may be further capable of executing instructions to remove a portion of the labelled data that is not associated with a reagent in an aspirating/dispensing operation.

In a particular example, for filtering the labelled data, the processor may be further capable of executing instructions to remove a portion of the labelled data labelled as normal flow for which a value of the sensor signal is not changing with time. For filtering the labelled data, the processor may be further capable of executing instructions to remove a portion of the labelled data labelled as normal flow for which the value of the sensor signal crosses one of an upper signal value and a lower signal value.

The advantages and effects discussed above for the automated analyzer are also achieved by the corresponding features of the method and the computing device and vice versa. Indeed, the computing device and the method of the present disclosure classify the aspirating/dispensing operation in the automated analyzer as correct or incorrect by applying the neural network model on the sensor signal generated by the at least one measurement sensor. In a case where the at least one measurement sensor is the pressure sensor, the computing device and the method classify the aspirating/dispensing operation by applying the neural network model to the voltage signal (i.e., the sensor signal). As the classification of the aspirating/dispensing operation is based on the neural network model having a plurality of convolution blocks, each including two convolution layers, there may be no need for calibration of the at least one measurement sensor for variations, such as sample/reagent type, environment conditions (temperature and atmospheric pressure), instrument assembly, length of the flow passage, inner diameter of the pipetting probe, and the like. In contrast to conventional techniques that require the calibration of the at least one measurement sensor, the method of the present disclosure may not involve any step comprising the calibration of the at least one measurement sensor. Therefore, a time that is utilized for the calibration in the conventional techniques may be saved in a testing process conducted according to the method of the present disclosure. This may further improve an efficiency of each of the computing device and the method in classifying the aspirating/dispensing operation in the automated analyzer. Moreover, as the method of the present disclosure does not involve the calibration of the at least one measurement sensor, any user error associated with the calibration process in the conventional techniques may not be present in the proposed method. This may improve an accuracy and a reliability of the method and the computing device of the present disclosure while classifying the aspirating/dispensing operation in the automated analyzer.

The method of the present disclosure further comprises generating the flag upon classification of the aspirating/dispensing operation as incorrect. In this way, preventive/remedial measures may be taken. The measures may include stopping or disallowing an ongoing process of analysis of a sample liquid (i.e., a patient sample). In some cases, upon classification of the aspirating/dispensing operation as an obstruction or no fluid, the operator may also check for any hardware failure, such as pump failure, a tubing failure, a valve failure, a probe failure, and the like. The operator can identify one or more hardware failures responsible for an abnormal aspirating/dispensing operation and rectify them accordingly. This may increase an uptime of the automated analyzer and therefore increase an overall efficiency of the automated analyzer.

As the computing device and the method of the present disclosure classify the aspirating/dispensing operation based on application of the neural network model having a plurality of convolution blocks, each including two convolution layers, the accuracy of the classification may not be affected by a type of the aspirating/dispensing operation. In other words, whether the aspirating/dispensing operation is a gross aspirating/dispensing operation or a partial aspirating/dispensing operation, the accuracy of the proposed method and the computing device may be substantially same in both the cases. Specifically, as compared to the conventional technique, the method of the present disclosure may accurately classify the partial aspirating/dispensing operation as correct or incorrect. Moreover, as the method of the present disclosure classifies the aspirating/dispensing operation based on the application of the neural network model, there may be no need of a minimum volume of the sample liquid in the aspirating/dispensing operation for an accurate classification. In contrast to the conventional techniques of classification, the method and the computing device of the present disclosure may accurately classify the aspirating/dispensing operation having less than 40 microliters of the sample liquid, e.g. up to 13 microliters.

The neural network model executed by the processor of the proposed computing device does not involve any processing of the sensor signal at the input layer. In other words, the processor does not perform any normalization or scaling of the sensor signal at the input layer. This may reduce a processing time of the processor capable of executing the neural network model. Therefore, as compared to the conventional techniques of classification of the aspirating/dispensing operation, the proposed computing device including the processor and the memory for storing the neural network model may take relatively less time to classify the aspirating/dispensing operation.

The neural network model executed by the computing device of the present disclosure may sequentially comprise the input layer, the plurality of convolution blocks, the flatten layer, and the probability layer. This particular sequential arrangement of the neural network model and an architecture of each of the plurality of convolution blocks may decrease a processing time required by the processor to classify the aspirating/dispensing operation in the automated analyzer. Therefore, a greater number of samples may be classified in a given time period, which may eventually further increase an overall efficiency of the automated analyzer. Further, a greater number of the plurality of second parameters than the number of the plurality of first parameters in the first convolution block may facilitate learning of the neural network model to detect or extract maximum features related to the classification of the aspirating/dispensing operation.

Furthermore, when the neural network model takes only the sensor signal as input, the method and the computing device are easily portable between different systems, e.g. different automated analyzers, since the neural network model does not need to have been trained on a specific configuration. Accordingly, the training of the neural network model is also easier.

For training the neural network model executed by the computing device of the present disclosure, the prior data is collected and labelled with the plurality of classifications. The labelled data is further filtered and then normalized to generate the training data configured to be used for training the neural network model. In some cases, filtering of the labelled data comprises various steps, such as removing the portion of the labelled data that is not associated with the pipetting device, removing the portion of the labelled data that is simulated, and removing the portion of the labelled data that is not associated with the reagent in the aspirating/dispensing operations. In some other cases, filtering of the labelled data comprises various steps, such as removing the portion of the labelled data labelled as normal flow for which the value of the sensor signal is not changing with time and removing the portion of the labelled data labelled as normal flow for which the value of the sensor signal crosses one of the upper signal value and the lower signal value. All these steps of filtering the labelled data before the training of the neural network model may ultimately decrease a processing time required by the processor for executing the neural network model. This may further improve an efficiency of the automated analyzer.

A variety of additional aspects will be set forth in the description that follows. These aspects can relate to individual features and to combinations of features. It is to be understood that both the foregoing summary and the following detailed description are exemplary and explanatory only and are not restrictive of the broad concepts upon which the embodiments disclosed herein are based.

### BRIEF DESCRIPTION OF THE FIGURES

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a block diagram of an automated analyzer including a computing device for classification of an aspirating/dispensing operation, according to an embodiment of the present disclosure;

FIG. 2 is a detailed schematic diagram of the automated analyzer of FIG. 1, according to an embodiment of the present disclosure;

FIG. 3A is an exemplary graph illustrating a pressure curve associated with an aspirating operation in the automated analyzer of FIG. 2;

FIG. 3B is another exemplary graph illustrating a pressure curve associated with an aspirating operation in the automated analyzer of FIG. 2;

FIG. 3C is another exemplary graph illustrating a pressure curve associated with an aspirating operation in the automated analyzer of FIG. 2;

FIG. 4 is a schematic layout of a neural network model used by the computing device of FIG. 1, according to an embodiment of the present disclosure;

FIG. 5 shows an exemplary convolution operation in the neural network model of FIG. 4;

FIG. 6 is a block diagram illustrating an activation function in the neural network model of FIG. 4;

FIG. 7 is a block diagram illustrating another activation function in the neural network model of FIG. 4;

FIG. 8 shows an exemplary pooling operation in the neural network model of FIG. 4;

FIG. 9 shows an exemplary flattening operation in the neural network model of FIG. 4;

FIG. 10 shows an exemplary classification operation in the neural network model of FIG. 4;

FIG. 11 is a flowchart of a process for classification of an aspirating/dispensing operation in the automated analyzer of FIG. 2, according to an embodiment of the present disclosure;

FIG. 12 illustrates parameters in various convolution layers of the neural network model of FIG. 4, according to an embodiment of the present disclosure;

FIG. 13 illustrates exemplary number of parameters in various layers of the neural network model of FIG. 4;

FIG. 14 is a flowchart of a process for generating training data for training the neural network model of FIG. 4, according to an embodiment of the present disclosure;

FIG. 15 is a flowchart of a process for filtering labelled data in the process of FIG. 14, according to an embodiment of the present disclosure;

FIG. 16 is a flowchart of a process for filtering labelled data in the process of FIG. 14, according to another embodiment of the present disclosure;

FIG. 17 is an exemplary graph illustrating a variation in a sensor signal with time for aspirating/dispensing operations;

FIG. 18 is a flowchart illustrating a method of classification of an aspirating/dispensing operation in the automated analyzer of FIG. 2, according to an embodiment of the present disclosure; and

FIG. 19 is a flowchart illustrating a method of generating, via each of plurality of convolution blocks, a corresponding block output in the neural network model of FIG. 4, according to an embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

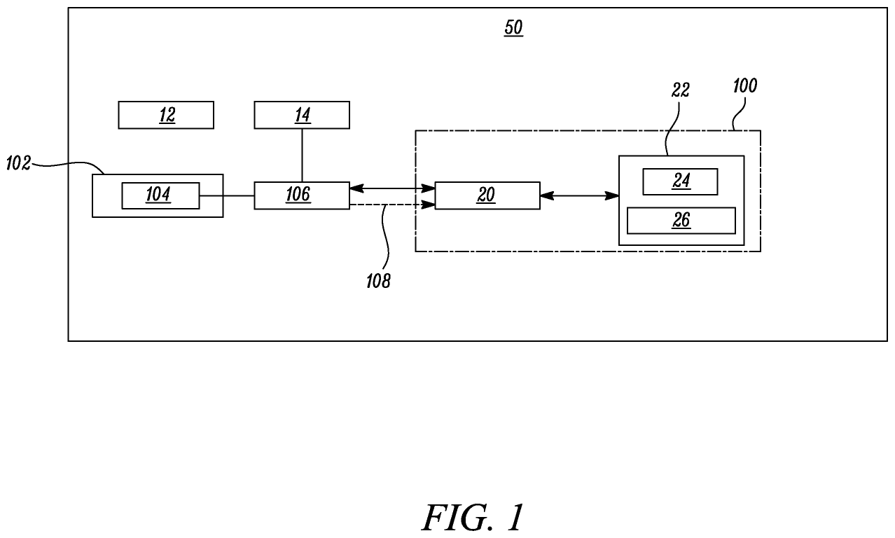

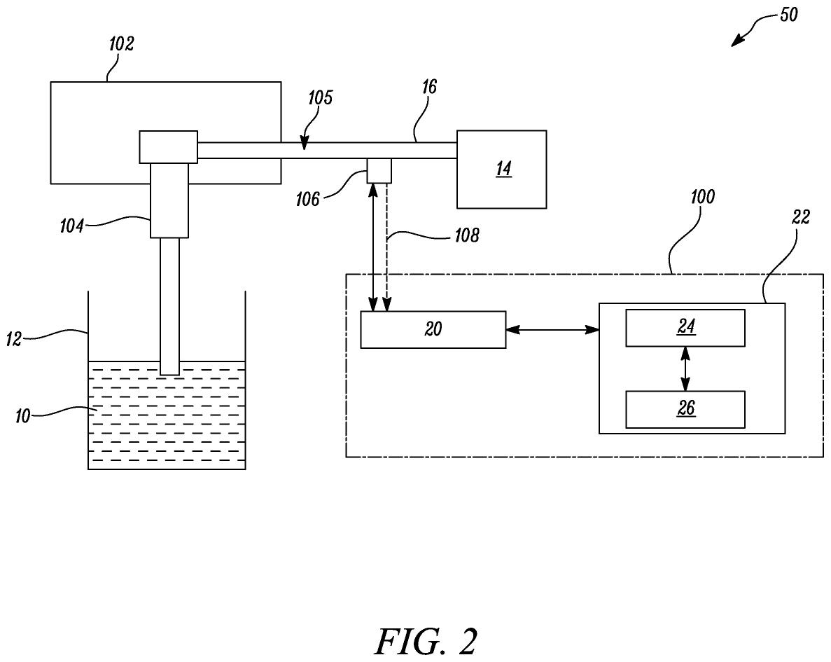

Referring now to Figures, FIG. 1 is a block diagram of an automated analyzer 50 including a computing device 100 for classification of an aspirating/dispensing operation, according to an embodiment of the present disclosure. FIG. 2 is a detailed schematic diagram of the automated analyzer 50. In some embodiments, the automated analyzer 50 is an immunoassay analyzer. In some embodiments, the automated analyzer 50 is a clinical analyzer. Referring to FIGS. 1 and 2, the automated analyzer 50 includes a pipetting device 102 including a pipetting probe 104 configured to conduct the aspirating/dispensing operation. In some cases, the pipetting device 102 may include a liquid handling arm (not shown) to move the pipetting probe 104 (e.g., to lower the pipetting probe 104 for the aspirating operation).

The automated analyzer 50 further includes a container 12 containing a sample liquid 10. The container 12 may be a culture bottle, a vessel, or a test tube. In some cases, the sample liquid may be a reagent. In some cases, the sample liquid 10 may be a mixture of the reagent, a biological sample, and a diluent. In some cases, the sample liquid 10 may be a bodily fluid, such as blood, serum, plasma, blood fractions, joint fluid, urine, and other body fluids. In some embodiments, the pipetting probe 104 may be configured to aspirate (i.e., the aspirating operation) the sample liquid 10 from the container 12. In other cases, the pipetting probe 104 may be configured to dispense (i.e., the dispensing operation) the sample liquid 10 into the container 12. The automated analyzer 50 may also include a reservoir (not shown) connected to the pipetting device 102. The reservoir may be used to store a dispensing liquid which is to be dispensed by the pipetting probe 104 into the container 12.

The automated analyzer 50 further includes a pump 14 connected to the pipetting probe 104 via a hose 16. The pump 14 may be used to apply a pressure (e.g., negative or positive pressure) on the hose 16 and the pipetting probe 104, such that the pipetting probe 104 conducts the aspirating/dispensing operation. Through the pressure applied by the pump 14, the pipetting probe 104 may aspirate or dispense the sample liquid 10 disposed in the container 12. The hose 16 defines a flow passage 105 between the pipetting probe 104 and the pump 14. A fluid pressure in the flow passage 105 may vary during the aspirating/dispensing operation.

The automated analyzer 50 further includes at least one measurement sensor 106 associated with the pipetting probe 104 of the pipetting device 102. In the illustrated embodiment of FIGS. 1 and 2, the at least one measurement sensor 106 includes only one measurement sensor 106. In some other embodiments, the at least one measurement sensor 106 may include two or more measurement sensors 106. In some cases, the at least one measurement sensor 106 may include an array of measurement sensors 106 spaced apart from each other. In the illustrated embodiment of FIG. 2, the at least one measurement sensor 106 is disposed in the flow passage 105 between the pipetting probe 104 and the pump 14. In some other embodiments, the at least one measurement sensor 106 may be disposed in the flow passage 105 as well as on the pipetting probe 104.

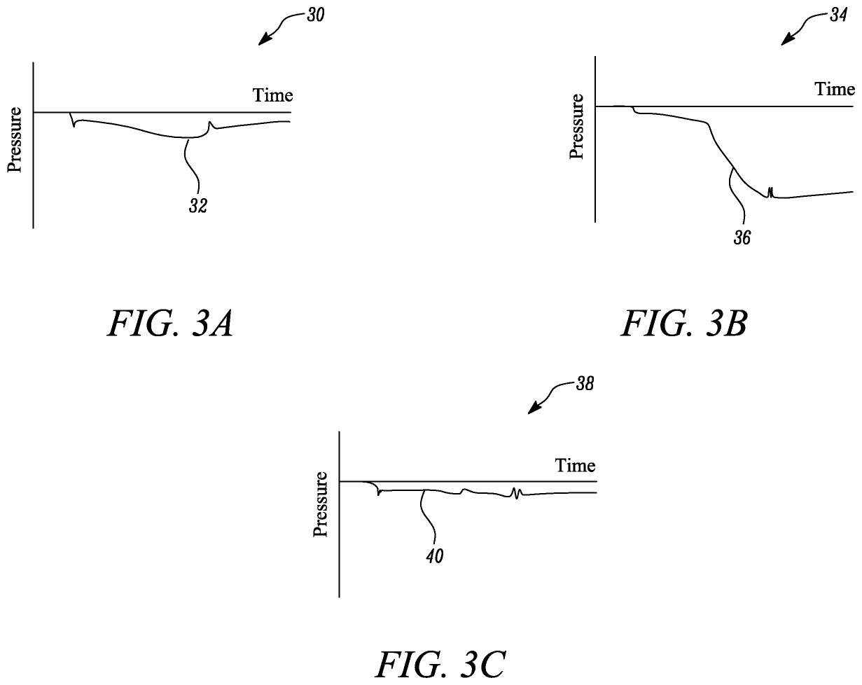

In some embodiments, the at least one measurement sensor 106 is configured to generate a sensor signal 108 indicative of a fluid parameter in the flow passage 105 of the pipetting probe 104. In some embodiments, the at least one measurement sensor 106 is a pressure sensor (e.g., a pressure transducer) and the flow parameter is pressure in the flow passage 105. In some other embodiments, the at least one measurement sensor 106 may be a flow sensor and the flow parameter may be flow rate in the flow passage 105. In some embodiments, the sensor signal 108 is a voltage signal. Specifically, the at least one measurement sensor 106 (i.e., the pressure sensor) may convert the detected pressure into an analog electrical signal. The at least one measurement sensor 106 may use strain gages and a diaphragm to produce the sensor signal 109 as the voltage signal. Generally, the sensor signal 108 defines or encodes a pressure curve that shows a waveform of pressure fluctuations in an aspirating/dispensing operation. Various pressure curves are illustrated in FIGS. 3A to 3C.

FIG. 3A shows an exemplary graph 30 illustrating a pressure curve 32 in case of a normal aspirating operation. Pressure in the flow passage 105 is depicted in arbitrary units (a.u.) on the ordinate. In the ordinate, an upper side depicts a positive pressure, and a lower side depicts a negative pressure with the atmospheric pressure being a reference. Time is depicted on the abscissa.

Referring to the curve 32, in the normal aspirating operation, the pressure starts to decrease at the start of the aspirating operation and then moderately changes during the aspiration. At the end of the aspirating operation, the pressure increases and return toward the atmospheric pressure reference.

FIG. 3B shows an exemplary graph 34 illustrating a pressure curve 36 in case of an obstructed aspirating operation. The obstructed aspirating operation may refer to a case where the pipetting probe 104 is completely clogged with an obstruction or a clot. Referring to the curve 36, the pressure starts to decrease at the start of the aspirating operation and further decreases at a greater extent when the obstruction occurs. The pressure does not restore at the end of the aspirating operation corresponding to the curve 36. The curve 36 differs in shape from the curve 32 corresponding to the normal aspirating operation.

FIG. 3C shows an exemplary graph 38 illustrating a pressure curve 40 in case of an empty aspirating operation. Referring to the curves 40, 36, and 32, pressure fluctuation is minimum in case of the empty aspirating operation. In case of the empty aspirating operation, pressure is hardly deflected to the negative side.

Therefore, in the sensor signal 108, the pressure curves (e.g., the curves 32, 36, and 40) comprise discrete pressure values over a given time. The pressure values are sampled at a fixed rate. The rate is same for all the pressure curves in different aspirating/dispensing operations. The pressure values of various pressure curves may be concatenated into a timely ordered vector which may be especially suited for being input into the neural network model 24. In other words, the sensor signal 108 may comprise a vector of timely ordered pressure values in various pressure curves.

Referring to FIGS. 1 and 2, the computing device 100 includes a memory 22 storing a neural network model 24, which will be described later. The memory may be a hard disk, a floppy disk, a flash memory, a ROM (Read Only Memory), an EPROM (Erasable Programmable Read Only Memory), or an USB (Universal Serial Bus) storage device. The computing device 100 further includes a processor 20 communicably coupled to the at least one measurement sensor 106 and the memory 22. The processor 20 is capable of executing the neural network model 24. For executing the neural network model 24, the processor 20 is further capable of executing instructions 26 stored in the memory 22. The processor 20 may be a programmable analog and/or digital device that can store, retrieve, and process data. In an application, the processor 20 may be a controller, a control circuit, a computer, a workstation, a microprocessor, a microcomputer, a central processing unit, a server, or any suitable device or apparatus.

The automated analyzer 50 may also include other components, such as feeder units, transfer units, sample racks, a wash wheel, etc. These components are not shown in FIGS. 1 and 2 for illustrative purposes.

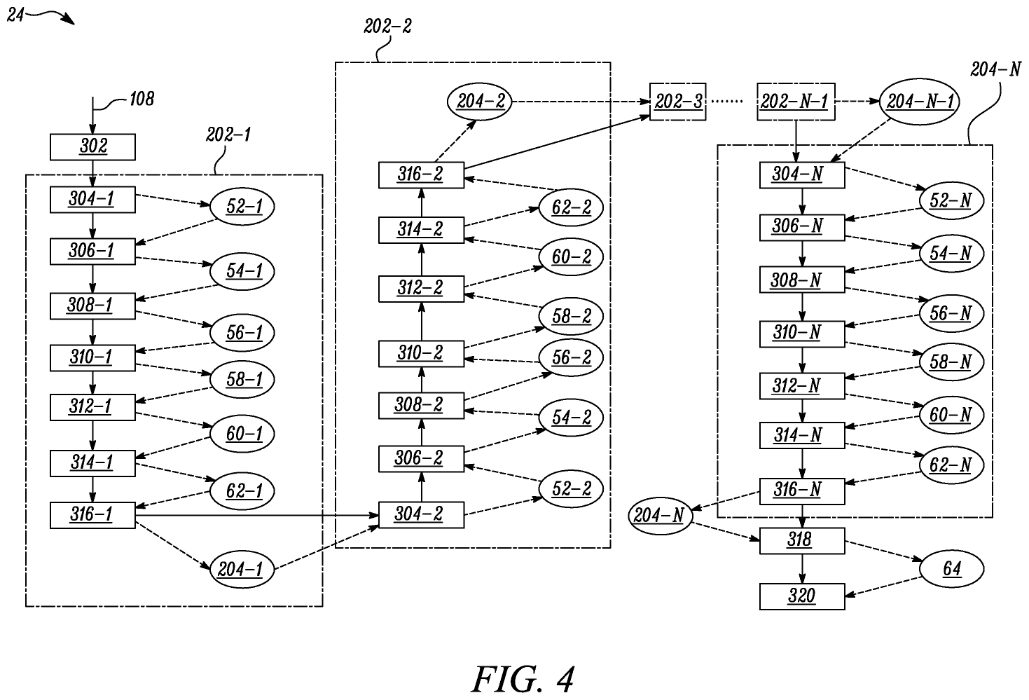

FIG. 4 is a schematic layout of the neural network model 24 executed by the processor 20 (shown in FIGS. 1 and 2) of the computing device 100, according to an embodiment of the present disclosure. The neural network model 24 includes a plurality of layers. Each layer may be a set of neurons, which receive input values from a previous layer and send output values to a next layer. Each neuron may have weights and, optionally, biases (defining filters or kernels) and the output values are calculated based on the input values and the weights.

Referring to FIGS. 1, 2, and 4, the neural network model 24 sequentially includes an input layer 302, a plurality of convolution blocks 202-1, 202-2 . . . 202-N, a flatten layer 318, and a probability layer 320. Once the sensor signal 108 is generated by the at least one measurement sensor 106 (shown in FIG. 2), the processor 20 is further capable of executing the instructions 26 to receive, via the input layer 302, the sensor signal 108 in real-time as the aspirating/dispensing operation occurs.

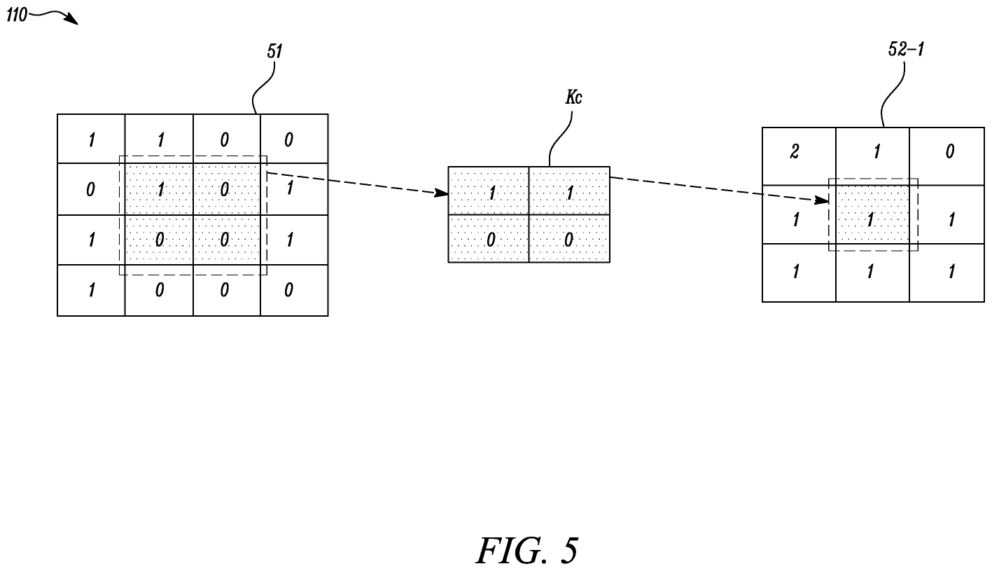

The neural network model 24 executed by the processor 20 does not involve any processing of the sensor signal 108 at the input layer 302. In other words, the processor 20 does not perform any normalization or scaling of the sensor signal 108 at the input layer 302. This may reduce a processing time of the processor 20 capable of executing the neural network model 24. Therefore, as compared to conventional techniques of classifying the aspirating/dispensing operation, the computing device 100 including the processor 20 and the memory 22 for storing the neural network model 24 may take relatively less time to classify the aspirating/dispensing operation. In some embodiments, the processor 20 is capable of executing the instructions 26 to perform zero padding to control and fix a size of an input feature map 51 (an example shown in FIG. 5) of the sensor signal 108.

The plurality of convolution blocks 202-1, 202-2 . . . 202-N sequentially includes a first convolution block 202-1 receiving the sensor signal 108 from the input layer 302, one or more intermediate convolution blocks 202-2, 202-3 . . . 202-N-1, and a last convolution block 202-N. In the illustrated embodiment of FIG. 4, only intermediate convolution block 202-2 from the intermediate convolution blocks 202-2, 202-3 . . . 202-N-1 is illustrated in detail.

The first convolution block 202-1 sequentially includes a first one-dimensional convolution layer 304-1, a first batch normalization layer 306-1, a first activation layer 308-1, a second one-dimensional convolution layer 310-1, a second batch normalization layer 312-1, a second activation layer 314-1, and a pooling layer 316-1. The intermediate convolution block 202-2 sequentially includes a first one-dimensional convolution layer 304-2, a first batch normalization layer 306-2, a first activation layer 308-2, a second one-dimensional convolution layer 310-2, a second batch normalization layer 312-2, a second activation layer 314-2, and a pooling layer 316-2. The last convolution block 202-N sequentially includes a first one-dimensional convolution layer 304-N, a first batch normalization layer 306-N, a first activation layer 308-N, a second one-dimensional convolution layer 310-N, a second batch normalization layer 312-N, a second activation layer 314-N, and a pooling layer 316-N. Therefore, in the neural network model 24, each of the plurality of convolution blocks 202-1, 202-2 . . . 202-N sequentially includes the first one-dimensional convolution layer 304-1, 304-2 . . . 304-N, the first batch normalization layer 306-1, 306-2 . . . 306-N, the first activation layer 308-1, 308-2 . . . 308-N, the second one-dimensional convolution layer 310-1, 310-2 . . . 310-N, the second batch normalization layer 312-1, 312-2 . . . 312-N, the second activation layer 314-1, 314-2 . . . 314-N, and the pooling layer 316-1, 316-2 . . . 316-N.

Once the first convolution block 202-1 receives the sensor signal 108 from the input layer 302, the processor 20 is further capable of executing the instructions 26 to generate, via the first convolution block 202-1, a first block output 204-1. The processor 20 is further capable of executing the instructions 26 to receive, via the intermediate convolution block 202-2, the first block output 204-1. The processor 20 is further capable of executing the instructions 26 to generate, via the intermediate convolution block 202-2, an intermediate block output 204-2. As the processing continues in the intermediate convolution blocks 202-3, 202-4 . . . 202-N-1, the processor 20 is further capable of executing the instructions 26 to receive, via the last convolution block 202-N, an intermediate block output 204-N-1 generated by the intermediate convolution block 202-N-1. Each intermediate convolution block 202-i (i=2, 3 . . . N−1) generates a corresponding intermediate block output 204-i that is received by the subsequent intermediate convolution block 204-(i+1) or the last convolution block 202-N (in case of i=N−1). The processor 20 is further capable of executing the instructions 26 to generate, via the last convolution block 202-N, a last block output 204-N. Therefore, during execution of the neural network model 24, the processor 20 is capable of executing the instructions 26 to generate, via each of the plurality of convolution blocks 202-1, 202-2 . . . 202-N, the corresponding block output 204-1, 204-2 . . . 204-N.

For generating the first block output 204-1, the processor 20 is further capable of executing the instructions 26 to determine a first feature map 52-1 by applying the first one-dimensional convolution layer 304-1 on the sensor signal 108 received from the input layer 302. FIG. 5 shows an exemplary convolution operation 110 performed by the first one-dimensional convolution layer 304-1 in the neural network model 24 executed by the processor 20. A convolution operation may be a linear operation that involves generating an output (i.e., the first feature map 52-1) by multiplication of a set of weights (kernels in the first one-dimensional convolution layer 304-1) with an input (i.e., the input feature map 51). Thus, by applying the first one-dimensional convolution layer 304-1 on the sensor signal 108, each element in the first feature map 52-1 is calculated using a kernel Kc having a predetermined size. In other words, the kernel Kc in the first one-dimensional convolution layer 304-1 is scanned across the input feature map 51 of the sensor signal 108. Generally, if a kernel detects a shape it has learned, it generates a higher valued output than a feature partially detected or not detected at all.

In the illustrated exemplary convolution operation 110 of FIG. 5, the input feature map 51 has a size of 4×4, and the kernel Kc has a size of 2×2. The neural network model 24 generates the first feature map 52-1 of an output by performing the convolution operation 110 between the input feature map 51 of the sensor signal 108 and the kernel Kc. The kernel Kc serve as the weights in the convolution operation 110. Specifically, the first one-dimensional convolution layer 304-1 performs the convolution operation 110 between the elements of the input feature map 51 and the elements of the kernel Kc while shifting the kernel Kc at a predetermined interval. The convolution operation 110 is performed by multiplying the elements of the input feature map 51 by the elements of the kernel Kc, and then accumulating the multiplication results (‘multiplication-accumulation operation’). For example, an element (1,1) of the first feature map 304-1 is calculated by performing a multiplication-accumulation operation according to following Equation 1:

$$( 1 * 1 ) + ( 1 * 1 ) + ( 0 * 0 ) + ( 1 * 0 ) = 2 \qquad ( Equation 1 )$$

Referring again to FIGS. 1, 2, and 4, for generating the first block output 204-1, the processor 20 is further capable of executing the instructions 26 to generate, via the first batch normalization layer 306-1, a first normalized feature map 54-1 by normalizing the first feature map 52-1 received from the first one-dimensional convolution layer 304-1. In other words, the first feature map 52-1 is normalized by the first batch normalization layer 306-1 to standardize an output (i.e., the first feature map 52-1) of the first one-dimensional convolution layer 304-1. Therefore, variable amplitudes in the first feature map 52-1 are regularized or normalized by the first batch normalization layer 306-1 to generate the first normalized feature map 54-1.

The first batch normalization layer 306-1 performs normalization on the first feature map 52-1 based on the statistical information of the first feature map 52-1. The statistical information may include mean and standard deviation of the first feature map 52-1. In some cases, the first feature map 52-1 are normalized to zero mean and unit variance. The inclusion of the first batch normalization layer 306-1 after the first one-dimensional convolution layer 304-1 may accelerate convergence of the neural network model 24. Further, while classifying the aspirating/dispensing operation, the first batch normalization layer 306-1 may also improve an accuracy of the neural network model 24 and avoid overfitting as well.

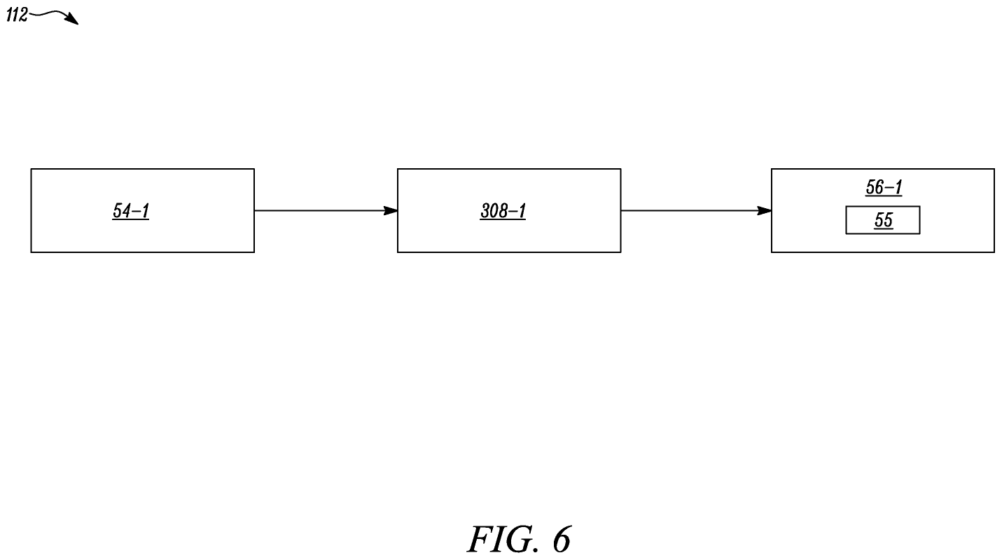

For generating the first block output 204-1, the processor 20 is further capable of executing instruction 26 to generate, via the first activation layer 308-1, a first activated feature map 56-1 by selecting a set of first features 55 (shown in FIG. 6) from the first normalized feature map 54-1 received from the first batch normalization layer 306-1. FIG. 6 is a block diagram illustrating an activation function 112 in the neural network model 24 executed by the processor 20. The activation function 112 is performed by the first activation layer 308-1 and includes selection of the set of first features 55 from the first normalized feature map 54-1. During the selection of the set of first features 55, all features/elements relevant for classification of the aspirating/dispensing operation are selected to be a part of the first activated feature map 56-1. For example, any data in the first normalized feature map 54-1 that is related to aspirating/dispensing operations is selected. Similarly, any data that is not related to aspirating/dispensing operations may be suppressed.

For selecting the set of first features 55, the activation function 112 may include a non-saturating activating function, or a Rectified Linear Unit (ReLU), or a swish function. In some cases, the activation function 112 may include identity functions, binary step functions, logistic (e.g., soft step) functions, hyperbolic tangent functions, arc-tangent functions, parametric ReLU functions, exponential linear unit functions, and soft-plus functions. The inclusion of the first activation layer 308-1 after the first batch normalization layer 306-1 may improve a computational efficiency of the neural network model 24 executed by the processor 20.

For generating the first block output 204-1, the processor 20 is further capable of executing the instructions 26 to determine a second feature map 58-1 by applying the second one-dimensional convolution layer 310-1 on the first activated feature map 56-1 received from the first activation layer 308-1. The second one-dimensional convolution layer 310-1 receives the first activated feature map 56-1 as an input and performs a convolution operation to determine the second feature map 58-1 as an output. The convolution operation performed by the second one-dimensional convolution layer 310-1 may be conducted in a manner similar to the convolution operation 110 (shown in FIG. 5) performed by the first one-dimensional convolution layer 304-1.

For generating the first block output 204-1, the processor 20 is further capable of executing the instructions 26 to generate, via the second batch normalization layer 312-1, a second normalized feature map 60-1 by normalizing the second feature map 58-1 received from the second one-dimensional convolution layer 310-1. The second batch normalization layer 312-1 receives the second feature map 58-1 as an input and performs normalization on the second feature map 58-1 to determine the second normalized feature map 60-1 as an output. The normalization performed by the second batch normalization layer 312-1 on the second feature map 58-1 may be conducted in a manner similar to the normalization performed by the first batch normalization layer 306-1 on the first feature map 52-1.

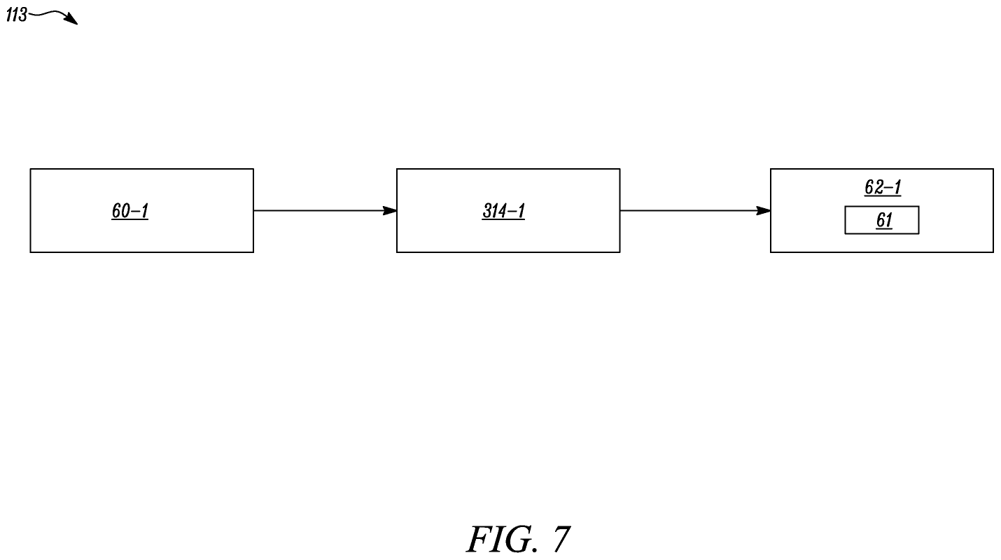

For generating the first block output 204-1, the processor 20 is further capable of executing the instructions 26 to generate, via the second activation layer 314-1, a second activated feature map 62-1 by selecting a set of second features 61 (shown in FIG. 7) from the second normalized feature map 60-1 received from the second batch normalization layer 312-1. FIG. 7 is a block diagram illustrating an activation function 113 in the neural network model 24 executed by the processor 20. The activation function 113 is performed by the second activation layer 314-1 and includes selection of the set of second features 61 from the second normalized feature map 60-1. The activation function 113 performed by the second activation layer 314-1 is conducted in a manner similar to the activation function 112 (shown in FIG. 6) performed by the first activation layer 308-1.

As the first convolution block 202-1 sequentially includes the first one-dimensional convolution layer 304-1, the first batch normalization layer 306-1, the first activation layer 308-1, the second one-dimensional convolution layer 310-1, the second batch normalization layer 312-1, the second activation layer 314-1, and the pooling layer 316-1, it can be stated that the first convolution block 202-1 includes two sequential arrangements of a one-dimensional convolution layer, a batch normalization layer, and an activation layer. By including the second one-dimensional convolution layer 310-1, the second batch normalization layer 312-1, and the second activation layer 314-1, the neural network model 24 learns, during training (described later), a combination of features which are unique to various types of classification of aspirating/dispensing operations.

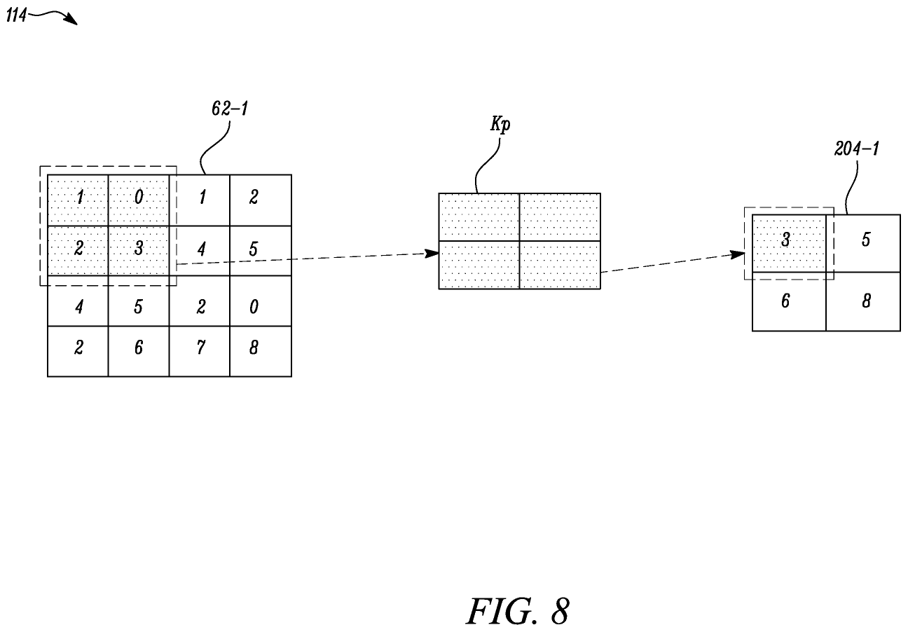

For generating the first block output 204-1, the processor 20 is further capable of executing the instructions 26 to generate, via the pooling layer 316-1, the first block output 204-1 by reducing a spatial size of the second activated feature map 62-1 received from the second activation layer 314-1. FIG. 8 shows an exemplary pooling operation 114 performed by the pooling layer 316-1 in the neural network model 24 executed by the processor 20. By applying the pooling layer 316-1 and performing pooling or subsampling operations on the second activated feature map 62-1, each element in the second activated feature map 62-1 is calculated using a kernel Kp having a predetermined size. In other words, the kernel Kp in the pooling layer 316-1 is scanned across the second activated feature map 62-1 received from the second activation layer 314-1.

In the illustrated exemplary pooling operation 114 of FIG. 8, the second activated feature map 62-1 has a size of 4×4, and the kernel Kp has a size of 2×2. The neural network model 24 generates an output feature map (i.e., the first block output 204-1) by performing the pooling operation 114 between the second activated feature map 62-1 and the kernel Kp. The kernel Kp serve as the weights in the pooling operation 114. Specifically, the pooling layer 316-1 performs the pooling operation 114 between the elements of the second activated feature map 62-1 and the elements of the kernel Kp while shifting the kernel Kp at a predetermined interval. Therefore, the neural network model 24 performs the pooling operation 114 between the second activated feature map 62-1 having a size of 4×4 and the kernel Kp having a size of 2×2 to generate the first block output 204-1 having a size of 2×2. Thus, a spatial size of the second activated feature map 62-1 is reduced by the pooling operation 114 performed by the pooling layer 316-1.

Further, it is assumed that the exemplary pooling operation 114 is performed while shifting the kernel Kp at the predetermined interval. The exemplary pooling operation 114 of FIG. 8 is a type of max pooling operation. Therefore, each element of the first block output 204-1 is calculated by selecting a maximum value in the second activated feature map 62-1 at each position of the kernel Kp during shifting. As an example, an element (1, 1) of the first block output 204-1 is calculated by performing the pooling operation 114 to select a maximum value according to following Equation 2:

$$Max ( 1 , 0 , 2 , 3 ) = 3 \qquad ( Equation 2 )$$

In some cases, the pooling operation 114 may be any one of operations for selecting an average value, an intermediate value, and a norm value. Further, the pooling layer 316-1 generates the first block output 204-1 by selecting only low-level features related to the aspirating/dispensing operation. The first block output 204-1 is further received by the intermediate convolution block 202-2.

The processor 20 is capable of executing the instructions 26 to receive, via the intermediate convolution block 202-2, the first block output 204-1 from the first convolution block 202-1. The processor 20 is further capable of executing the instructions 26 to generate, via the intermediate convolution block 202-2, the intermediate block output 204-2. For generating the intermediate block output 204-2, the processor 20 is further capable of executing the instructions 26 to determine a first feature map 52-2 by applying the first one-dimensional convolution layer 304-2 on the first block output 204-1 received from the first convolution block 202-1. The processor 20 is further capable of executing the instructions 26 to generate, via the first batch normalization layer 306-2, a first normalized feature map 54-2 by normalizing the first feature map 52-2 received from the first one-dimensional convolution layer 304-2. The processor 20 is further capable of executing the instructions 26 to generate, via the first activation layer 308-2, a first activated feature map 56-2 by selecting a set of first features from the first normalized feature map 54-2 received from the first batch normalization layer 306-2.

For generating the intermediate block output 204-2, the processor 20 is further capable of executing the instructions 26 to determine a second feature map 58-2 by applying the second one-dimensional convolution layer 310-2 on the first activated feature map 56-2 received from the first activation layer 308-2. The processor 20 is further capable of executing the instructions 26 to generate, via the second batch normalization layer 312-2, a second normalized feature map 60-2 by normalizing the second feature map 58-2 received from the second one-dimensional convolution layer 310-2. The processor 20 is further capable of executing the instructions 26 to generate, via the second activation layer 314-2, a second activated feature map 62-2 by selecting a set of second features from the second normalized feature map 60-2 received from the second batch normalization layer 312-2. The processor 20 is further capable of executing the instructions 26 to generate, via the pooling layer 316-2, the intermediate block output 204-2 by reducing a spatial size of the second activated feature map 62-2 received from the second activation layer 314-2. The processing of the different layers of the intermediate convolution block 202-2 may be substantially similar to the processing of the corresponding layers of the first convolution block 202-1, as discussed above.

The processor 20 is further capable of executing the instructions 26 to receive, via the intermediate convolution block 202-3, the intermediate block output 204-2. As the processing continues in the intermediate convolution blocks 202-3, 202-4 . . . 202-N-1, the processor 20 is further capable of executing the instructions 26 to receive, via the last convolution block 202-N, the intermediate block output 204-N-1 from the intermediate convolution block 202-N-1. The processing of each of the intermediate convolution blocks 202-3, 202-4 . . . 202-N-1 may be substantially similar to the processing of the intermediate convolution block 202-2.

The processor 20 is further capable of executing the instructions 26 to generate, via the last convolution block 202-N, the last block output 204-N. For generating the last block output 204-N, the processor 20 is further capable of executing the instructions 26 to determine a first feature map 52-N by applying the first one-dimensional convolution layer 304-N on the intermediate block output 204-N-1 received from the intermediate convolution block 202-N-1. The processor 20 is further capable of executing the instructions 26 to generate, via the first batch normalization layer 306-N, a first normalized feature map 54-N by normalizing the first feature map 52-N received from the first one-dimensional convolution layer 304-N. The processor 20 is further capable of executing the instructions 26 to generate, via the first activation layer 308-N, a first activated feature map 56-N by selecting a set of first features from the first normalized feature map 54-N received from the first batch normalization layer 306-N.

For generating the last block output 204-N, the processor 20 is further capable of executing the instructions 26 to determine a second feature map 58-N by applying the second one-dimensional convolution layer 310-N on the first activated feature map 56-N received from the first activation layer 308-N. The processor 20 is further capable of executing the instructions 26 to generate, via the second batch normalization layer 312-N, a second normalized feature map 60-N by normalizing the second feature map 58-N received from the second one-dimensional convolution layer 310-N. The processor 20 is further capable of executing the instructions 26 to generate, via the second activation layer 314-N, a second activated feature map 62-N by selecting a set of second features from the second normalized feature map 60-N received from the second batch normalization layer 312-N. The processor 20 is further capable of executing the instructions 26 to generate, via the pooling layer 316-N, the last block output 204-N by reducing a spatial size of the second activated feature map 62-N received from the second activation layer 314-N.

Therefore, for generating the corresponding block output 204-1, 204-2 . . . 204-N in the neural network model 24, the processor 20 is capable of executing the instructions 26 to determine the first feature map 52-1, 52-2 . . . 52-N by applying the first one-dimensional convolution layer 304-1, 304-2 . . . 304-N on the sensor signal 108 received from the input layer 302 or the corresponding block output 204-1, 204-2 . . . 204-N-1 received from a previous convolution block 202-1, 202-2 . . . 202-N-1 from the plurality of convolution blocks 202-1, 202-2 . . . 202-N. As already stated above, for generating the first block output 204-1, the processor 20 is capable of executing the instructions 26 to determine the first feature map 52-1 by applying the first one-dimensional convolution layer 304-1 on the sensor signal 108 received from the input layer 302. Further, for generating the corresponding block output 204-2, 204-3 . . . 204-N, the processor 20 is capable of executing the instructions 26 to determine the first feature map 52-2, 52-3 . . . 52-N by applying the first one-dimensional convolution layer 304-2, 304-3 . . . 304-N on the corresponding block output 204-1, 204-2 . . . 204-N-1 received from the corresponding convolution block 202-1, 202-2 . . . 202-N-1.

Further, for generating the corresponding block output 204-1, 204-2 . . . 204-N in the neural network model 24, the processor 20 is capable of executing the instructions 26 to generate, via the first batch normalization layer 306-1, 306-2 . . . 306-N, the first normalized feature map 54-1, 54-2 . . . 54-N by normalizing the first feature map 52-1, 52-2 . . . 52-N received from the corresponding first one-dimensional convolution layer 304-1, 304-2 . . . 304-N. The processor 20 is further capable of executing the instructions 26 to generate, via the first activation layer 308-1, 308-2 . . . 308-N, the first activated feature map 56-1, 56-2 . . . 56-N by selecting the corresponding set of first features from the first normalized feature map 54-1, 54-2 . . . 54-N received from the corresponding first batch normalization layer 306-1, 306-2 . . . 306-N.

Further, for generating the corresponding block output 204-1, 204-2 . . . 204-N in the neural network model 24, the processor 20 is capable of executing the instructions 26 to determine the second feature map 58-1, 58-2 . . . 58-N by applying the second one-dimensional convolution layer 310-1, 310-2 . . . 310-N on the first activated feature map 56-1, 56-2 . . . 56-N received from the corresponding first activation layer 308-1, 308-2 . . . 308-N. The processor 20 is further capable of executing the instructions 26 to generate, via the second batch normalization layer 312-1, 312-2 . . . 312-N, the second normalized feature map 60-1, 60-2 . . . 60-N by normalizing the second feature map 58-1, 58-2 . . . 58-N received from the corresponding second one-dimensional convolution layer 310-1, 310-2 . . . 310-N. The processor 20 is further capable of executing the instructions 26 to generate, via the second activation layer 314-1, 314-2 . . . 314-N, the second activated feature map 62-1, 62-2 . . . 62-N by selecting the corresponding set of second features from the second normalized feature map 60-1, 60-2 . . . 60-N received from the corresponding second batch normalization layer 312-1, 312-2 . . . 312-N.

Further, for generating the corresponding block output 204-1, 204-2 . . . 204-N in the neural network model 24, the processor 20 is capable of executing the instructions 26 to generate, via the pooling layer 316-1, 316-2 . . . 316-N, the corresponding block output 204-1, 204-2 . . . 204-N by reducing a spatial size of the second activated feature map 62-1, 62-2 . . . 62-N received from the corresponding second activation layer 314-1, 314-2 . . . 314-N. The last convolution block 202-N provides the last block output 204-N to the flatten layer 318.

The processor 20 is further capable of executing the instructions 26 to generate, via the flatten layer 318, a one-dimensional vector output 64 by converting the corresponding block output (i.e., the last block output 204-N) received from the previous convolution block (i.e., the last convolution block 202-N). In an example, the flatten layer 318 may expand a two-dimensional output feature vector (i.e., the last output block 204-N) into a one-dimensional feature vector. In other words, the flatten layer 318 converts the last block output 204-N to flattened extracted features (i.e., a single column matrix).

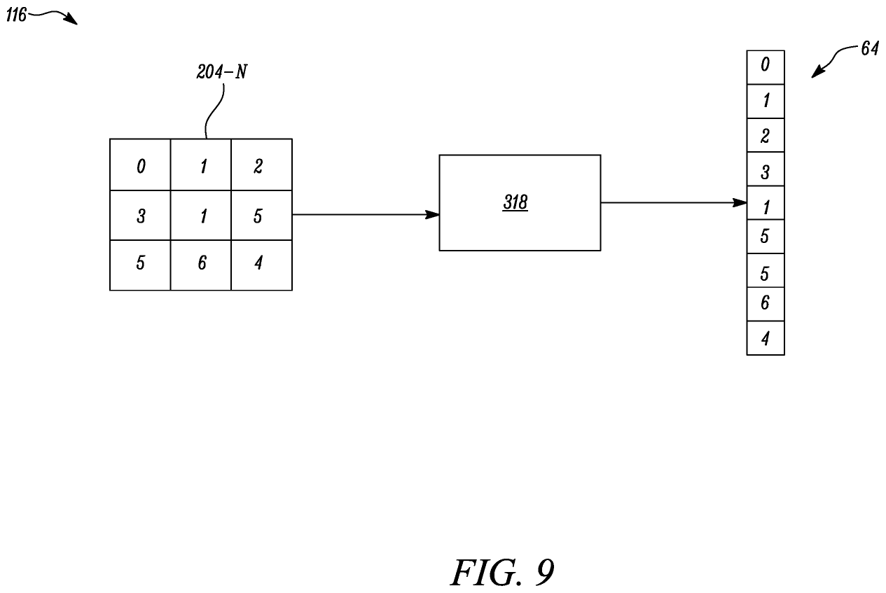

FIG. 9 shows an exemplary flattening operation 116 performed by the flatten layer 318 in the neural network model 24 executed by the processor 20. The flattening operation 116 may be performed by the processor 20. In the illustrated exemplary flattening operation 116, input (i.e., the last output block 204-N) has a size of 3×3 and output is the one-dimensional vector output 64.

Referring to FIG. 4, the processor 20 is further capable of executing the instructions 26 to classify, via the probability layer 320, the aspirating/dispensing operation as one of correct/normal, obstructed, and empty by using the one-dimensional vector output 64 received from the flatten layer 318. Specifically, the probability layer 320 provides an output depicting probability values for different classification types (normal, obstructed, empty) of the aspirating/dispensing operation.

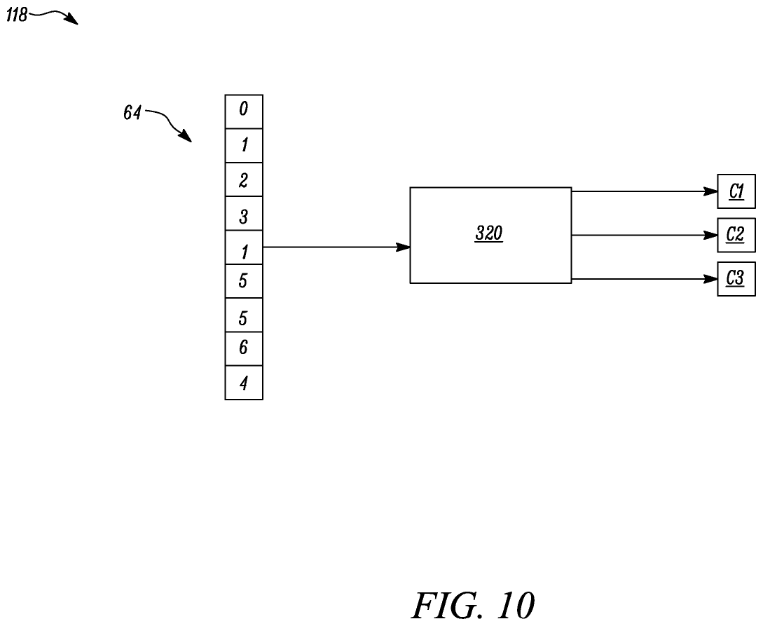

FIG. 10 shows an exemplary classification operation 118 performed by the probability layer 320 in the neural network model 24 executed by the processor 20. Based on the one-dimensional vector output 64, the probability layer 320 determines a probability C1 of the aspirating/dispensing operation being classified as correct, a probability C2 of the aspirating/dispensing operation being classified as obstructed, and a probability C3 of the aspirating/dispensing operation being classified as empty. The probability layer 320 may classify the aspirating/dispensing operation as normal if the probability C1 is greater than each of the probability C2 and the probability C3. The probability layer 320 may classify the aspirating/dispensing operation as obstructed if the probability C2 is greater than each of the probability C1 and the probability C3. The probability layer 320 may classify the aspirating/dispensing operation as empty if the probability C3 is greater than each of the probability C1 and the probability C2.

In some embodiments, the processor 20 is further capable of executing the instructions 26 to generate a flag upon classification of the aspirating/dispensing operation as obstructed or empty. In some cases, the processor 20 may control an output device (not shown) to provide an output indicating that the aspirating/dispensing operation has been classified as obstructed or empty. In some cases, the output may include a notification for an operator to check for an obstruction in the aspirating/dispensing operation. In some cases, the output may include a notification for an operator to check for empty (i.e., no fluid) aspirating/dispensing operation. In some cases, the output may include a visual alert, a text message, an audible signal, an alarm, or combinations thereof. In some cases, the processor 20 is capable of executing instructions to stop an analysis process upon generation of the flag. In other words, the automated analyzer 50 may interrupt the analysis of the sample liquid. After the cause of the incorrect aspirating/dispensing operation has been addressed, the automated analyzer 50 may perform another aspirating/dispensing operation.

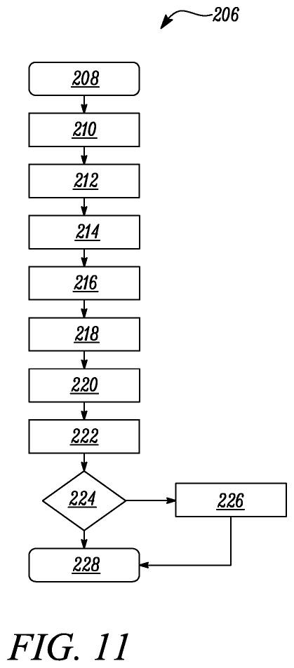

FIG. 11 is a flowchart of a process 206 for classification of the aspirating/dispensing operation in the automated analyzer 50 (shown in FIGS. 1 and 2), according to an embodiment of the present disclosure. The process 206 uses the neural network model 24 (shown in FIG. 4) for classification of the aspirating/dispensing operation. The process 206 is embodied as a machine learning algorithm implemented by the computing device 100 (shown in FIGS. 1 and 2) including the processor 20. Further, the process 206 may be stored in the memory 22 as instructions executable by the processor 20. In some cases, the process 206 may be part of the instructions 26 stored in the memory 22.

At operation 208, the process 206 begins. Referring to FIGS. 1, 2, 4, and 11, at operation 210, the at least one measurement sensor 106 generates the sensor signal 108 indicative of a fluid parameter in the flow passage 105 of the pipetting probe 104. In some embodiments, the at least one measurement sensor 106 is the pressure sensor (pressure transducer) and the flow parameter is pressure in the flow passage 105. In some embodiments, the sensor signal 108 is a voltage signal. The process 206 further moves to operation 212.

At the operation 212, the processor 20 executes the instructions 26 to provide or activate the neural network model 24. The process 206 further moves to operation 214. At the operation 214, the input layer 302 receives the sensor signal 108 in real-time as the aspirating/dispensing operation occurs. The process 206 further moves to operation 216.

At the operation 216, the first convolution block 202-1 receives the sensor signal 108 and determines the first block output 204-1. A procedure followed by the first convolution block 202-1 to determine the first block output 204-1 is already explained with respect to FIG. 4. Once the first block output 204-1 is determined, the process 206 further moves to operation 218.

At the operation 218, the intermediate convolution blocks 202-2, 202-3 . . . 202-N-1 determine the corresponding intermediate block outputs 204-2, 204-2 . . . 204-N-1. A procedure followed by the intermediate convolution blocks 202-2, 202-3 . . . 202-N-1 to determine the corresponding intermediate block outputs 204-2, 204-2 . . . 204-N-1 is already explained with respect to FIG. 4. Once the intermediate block output 204-N-1 is determined, the process 206 further moves to operation 220.

At the operation 220, the last convolution block 202-N receives the intermediate block output 204-N-1 and determines the last block output 204-N. The process 206 further moves to operation 222. At the operation 222, the flatten layer 318 generates the one-dimensional vector output 64 by converting the last block output 204-N received from the last convolution block 202-N. The process 206 further moves to operation 224.

At the operation 224, the probability layer 320 classifies the aspirating/dispensing operation as one of correct, obstructed, and empty by using the one-dimensional vector output 64 received from the flatten layer 318. If the probability layer 320 classifies the aspirating/dispensing operation as correct, the process 206 moves to operation 228 where the process 206 is terminated.

If the probability layer 320 classifies the aspirating/dispensing operation as one of obstructed or empty, the process 206 further moves to operation 226. At the operation 226, the processor 20 executes the instructions 26 to generate a flag upon classification of the aspirating/dispensing operation as an obstruction or no fluid. Preventive/remedial measures can be taken as the automated analyzer 50 may otherwise provide erroneous test results of a patient sample. The preventive/remedial measures may include stopping or disallowing an ongoing process of analysis of the sample liquid 10 (i.e., a patient sample). In some cases, upon classification of the aspirating/dispensing operation as obstructed or empty, the operator may also check for any hardware failure, such as a pump failure, a tubing failure, a valve failure, a probe failure, and the like. The operator can identify one or more hardware failures responsible for an abnormal aspirating/dispensing operation and rectify them accordingly. This may increase an uptime of the automated analyzer 50 and therefore increase an overall efficiency of the automated analyzer 50 including the computing device 100.

Referring to FIGS. 1, 2, 4, and 11, the computing device 100 classifies the aspirating/dispensing operation in the automated analyzer 50 as one of normal, obstructed, and empty by applying the neural network model 24 on the sensor signal 108 generated by the at least one measurement sensor 106. In a case where the at least one measurement sensor 106 is the pressure sensor, the computing device 100 classifies the aspirating/dispensing operation by applying the neural network model 24 to the voltage signal (i.e., the sensor signal 108). As the classification of the aspirating/dispensing operation is based on the neural network model 24, there may be no need for calibration of the at least one measurement sensor 106 for variations, such as sample/reagent type, environment conditions (temperature and atmospheric pressure), instrument assembly, length of the flow passage 105, inner diameter of the pipetting probe 104, and the like. In contrast to the conventional techniques that require the calibration of the at least one measurement sensor 106, the process 206 implemented by the computing device 100 may not involve any step comprising the calibration of the at least one measurement sensor 106. Therefore, a time that is utilized for the calibration in the conventional techniques may be saved in a testing process (e.g., the process 206) conducted by the automated analyzer 50. This may increase an efficiency of the method of classification of the aspirating/dispensing operation in the automated analyzer 50. Moreover, as the process 206 of classification of the aspirating/dispensing operation does not involve calibration of the at least one measurement sensor 106, any user error associated with the calibration process in the conventional techniques may not be present in the process 206 implemented by the computing device 100. This may further improve an accuracy and a reliability of the computing device 100 while classifying the aspirating/dispensing operation in the automated analyzer 50.

As the computing device 100 classifies the aspirating/dispensing operation based on application of the neural network model 24, the accuracy of the classification (i.e., accuracy of the process 206) may not be affected by a type of the aspirating/dispensing operation. In other words, whether the aspirating/dispensing operation is a gross aspirating/dispensing operation or a partial aspirating/dispensing operation, the accuracy of the process 206 implemented by the computing device 100 may be substantially same in both the cases. Specifically, as compared to the conventional techniques, the computing device 100 including the processor 20 may accurately classify the partial aspirating/dispensing operation as one of normal, obstructed, and empty. Moreover, as the computing device 100 classifies the aspirating/dispensing operation based on the application of the neural network model 24, there may be no need of a minimum volume of the sample liquid 10 in the aspirating/dispensing operation for an accurate classification. In contrast to the conventional techniques of classification, the computing device 100 may accurately classify the aspirating/dispensing operation having less than 40 microliters of the sample liquid 10, e.g. up to 13 microliters.

The neural network model 24 executed by the computing device 100 sequentially comprises the input layer 302, the plurality of convolution blocks 202-1, 202-2 . . . 202-N, the flatten layer 318, and the probability layer 320. This particular sequential arrangement of the neural network model 24 and an architecture of each of the plurality of convolution blocks 202-1, 202-2 . . . 202-N may decrease a processing time required by the processor 20 to classify the aspirating/dispensing operation in the automated analyzer 50. Therefore, a greater number of samples may be classified in a given time period, which may eventually further increase an overall efficiency of the automated analyzer 50.

In general, in a neural network model, a convolution layer has a number of parameters (i.e., trainable parameters). The number of parameters in a convolution layer is the count of learnable or trainable elements for a filter of that convolution layer. Total number of parameters in a convolution layer is a sum of all weights and biases in the convolution layer. The total number of parameters in a convolution layer are calculated according to following Equation 3:

$${P}_{c} = {W}_{c} + {B}_{c} \qquad ( Equation 3 )$$

where, P_{c} is total number of parameters in the convolution layer;
W_{c} is number of weights in the convolution layer; and
B_{c} is number of biases in the convolution layer.

The number of biases in the convolutional layer is same as the number of filters (kernels) associated with that convolution layer. The number of weights W_{c} in the convolution layer can be calculated according to following Equation 4:

$${W}_{c} = {K}^{2} * C * N \qquad ( Equation 4 )$$

where, K is size (width) of kernels used in the convolution layer;
N is number of kernels; and
C is number of channels of an input received by the convolution layer.

In an example, for a convolution layer, the number of channels (C) of an input is 3, the kernel size (K) is 11, and the number of kernels (N) is 96. So, the total number of parameters P_{c} are calculated according to following Equation 5:

$${P}_{c} = ( 11 * 11 * 3 * 96 ) + 96 = 34944 \qquad ( Equation 5 )$$

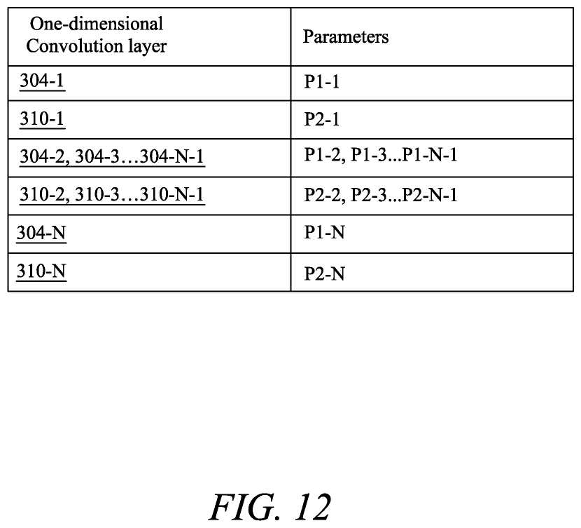

FIG. 12 illustrates parameters in various convolution layers of the neural network model 24 of FIG. 4, according to an embodiment of the present disclosure. In some embodiments, the first one-dimensional convolution layer 304-1, 304-2 . . . 304-N of each of the plurality of convolution blocks 202-1, 202-2 . . . 202-N includes a corresponding plurality of first parameters P1-1, P1-2 . . . . P1-N. Therefore, the first one-dimensional convolution layer 304-1 of the first convolution block 202-1 includes the plurality of first parameters P1-1. The first one-dimensional convolution layer 304-2 of the intermediate convolution block 202-2 includes the plurality of first parameters P1-2. The first one-dimensional convolution layer 304-N of the last convolution block 202-2 includes the plurality of first parameters P1-N.

In some embodiments, the second one-dimensional convolution layer 310-1, 310-2 . . . 310-N of each of the plurality of convolution blocks 202-1, 202-2 . . . 202-N includes a corresponding plurality of second parameters P2-1, P2-2 . . . . P2-N. Therefore, the second one-dimensional convolution layer 310-1 of the first convolution block 202-1 includes the plurality of second parameters P2-1. The second one-dimensional convolution layer 310-2 of the intermediate convolution block 202-2 includes the plurality of second parameters P2-2. The second one-dimensional convolution layer 310-N of the last convolution block 202-N includes the plurality of second parameters P2-N.

In some embodiments, a number of the plurality of second parameters P2-1, P2-2 . . . . P2-N is greater than or equal to a number of the corresponding plurality of first parameters P1-1, P1-2 . . . . P1-N. In some embodiments, for the first convolution block 202-1, the number of the plurality of second parameters P2-1 is greater than the number of the plurality of first parameters P1-1 by a factor of at least 50. A greater number of the plurality of second parameters P2-1 than the number of the plurality of first parameters P1-1 in the first convolution block 202-1 may facilitate learning of the neural network model 24 to detect or extract maximum features related to the classification of the aspirating/dispensing operation. In some embodiments, for each of the one or more intermediate convolution blocks 202-2, 202-3 . . . 202-N-1, the number of the plurality of second parameters P2-2, P2-3 . . . . P2-N-1 is equal to the number of the corresponding plurality of first parameters P1-2, P1-3 . . . . P1-N-1. Therefore, for the intermediate convolution block 202-2, the number of the plurality of second parameters P2-2 is equal to the number of the plurality of first parameters P1-2. In some embodiments, for the last convolution block 202-N, the number of the plurality of second parameters P2-N is equal to the number of the plurality of first parameters P1-N.

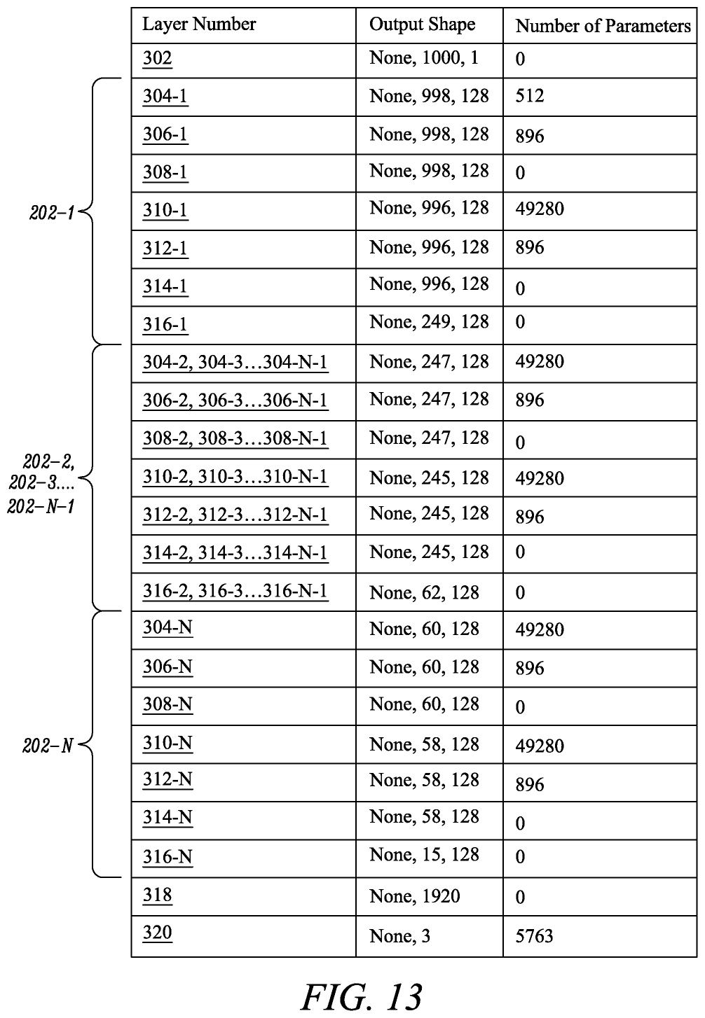

FIG. 13 illustrates exemplary number of parameters in various layers of the neural network model 24. FIG. 13 also illustrates an exemplary output shape determined or generated by each layer in the neural network model 24. The output shape refers to a data structure or data output (i.e., vector/matrix/tensor structure/size) provided by a given layer of the neural network model 24. The output shape of one layer is received by a subsequent layer in the neural network model 24. For the first convolution block 202-1, the number of the plurality of first parameters P1-1 equals 512 and the number of the plurality of second parameters P2-1 equals 49280. Therefore, in the illustrated example of FIG. 13, the number of the plurality of second parameters P2-1 (equals 49280) is greater than the number of the plurality of first parameters P1-1 (equals 512) by the factor of at least 50. Specifically, in this example, the number of the plurality of second parameters P2-1 is greater than the number of the plurality of first parameters P1-1 (equals 512) by a factor of 96.25.

For the intermediate convolution block 202-2, the number of the plurality of second parameters P2-2 equals 49280 and the number of the plurality of first parameters P1-2 also equals 49280. Further, for the intermediate convolution block 202-N-1, the number of the plurality of second parameters P2-N-1 equals 49280 and the number of the plurality of first parameters P1-N-1 also equals 49280. Therefore, in the illustrated example of FIG. 13, for each of the one or more intermediate convolution blocks 202-2, 202-3 . . . 202-N-1, the number of the plurality of second parameters P2-2, P2-3 . . . . P2-N-1 (each equals 49280) is equal to the number of the corresponding plurality of first parameters P1-2, P1-3 . . . . P1-N-1 (each equals 49280).

For the last convolution block 202-N, the number of the plurality of second parameters P2-N equals 49280 and the number of the plurality of first parameters P1-N also equals 49280. Therefore, for the last convolution block 202-N, the number of the plurality of second parameters P2-N (equals 49280) is equal to the number of the plurality of first parameters P1-N (equals 49280).

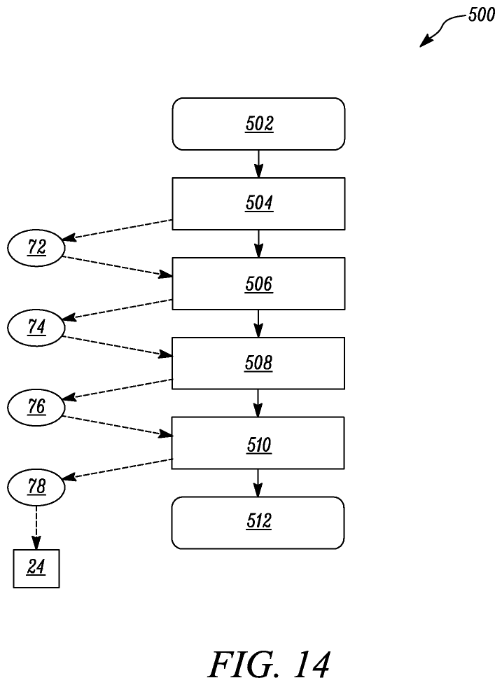

FIG. 14 is a flowchart of a process 500 for generating training data 78 for training the neural network model 24 (shown in FIG. 4), according to an embodiment of the present disclosure. The process 500 is embodied as a machine learning algorithm implemented by the computing device 100 (shown in FIGS. 1 and 2) including the processor 20. Further, the process 500 may be stored in the memory 22 as instructions executable by the processor 20. In some cases, the process 500 may be part of the instructions 26 stored in the memory 22.

The training data 78 may be a set of measurement data of already classified aspirating/dispensing operations conducted in the past. The training data 78 may include the various types of classifications for a plurality of aspirating/dispensing operations.

For generating the training data 78, the processor 20 is further capable of executing the instructions 26 to collect prior data 72 associated with the plurality of aspirating/dispensing operations. At operation 502, the process 500 begins. Referring to FIGS. 1, 2, 4, and 14, at operation 504, the processor 20 collects the prior data 72 associated with the plurality of aspirating/dispensing operations. The process 500 further moves to operation 506.

For generating the training data 78, the processor 20 is further capable of executing the instructions 26 to label the prior data 72 with a plurality of classifications to generate labelled data 74. At the operation 506, the processor 20 labels the prior data 72 with the plurality of classifications to generate the labelled data 74. Each of the plurality of classifications is associated with a corresponding aspirating/dispensing operation from the plurality of aspirating/dispensing operations. Further, each of the plurality of classifications is one of correct, obstructed, and empty. Therefore, each element in the prior data 72 may be labelled with a corresponding classification in order to generate the labelled data 74. The process 500 further moves to operation 508.

For generating the training data 78, the processor 20 is further capable of executing the instructions 26 to filter the labelled data 74 to generate filtered data 76. At the operation 508, the processor 20 filters the labelled data 74 to generate the filtered data 76. Some of the methods to filter the labelled data 74 will be described later. The process 500 further moves to operation 510.

For generating the training data 78, the processor 20 is further capable of executing the instructions 26 to normalize the filtered data 76 based on one or more parameters to generate the training data 78. At the operation 510, the processor 20 normalizes the filtered data 76 based on the one or more parameters to generate the training data 78.

The filtered data 76 needs to be normalized or standardized, such that all values in the filtered data 76 are within an acceptable range. In some cases, various scaling techniques, such as MinMaxScaler may be used to normalize the filtered data 76. The one or more parameters may include a volume of sample liquids in the plurality of aspirating/dispensing operations, a type of pipetting probe used in the plurality of aspirating/dispensing operations, a diameter of flow passage in the plurality of aspirating/dispensing operations, environmental conditions, type of sample liquid in the plurality of aspirating/dispensing operations, and so on.

Once the training data 78 is generated, the processor 20 stores the training data 78 in the neural network model 24. The process 500 further moves to operation 512 where the process 500 is terminated.

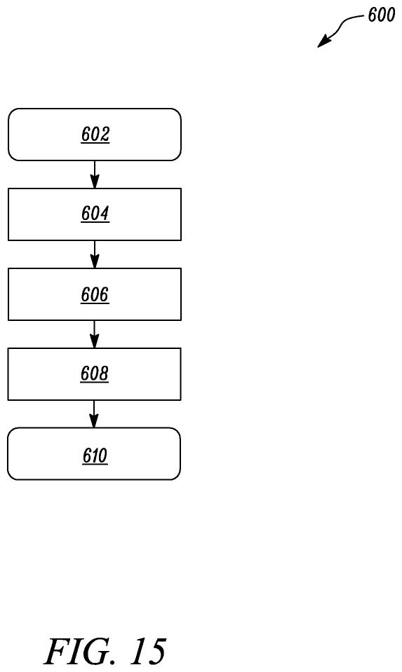

FIG. 15 is a flowchart of a process 600 for filtering the labelled data 74 (shown in FIG. 14), according to an embodiment of the present disclosure. The process 600 is embodied as a machine learning algorithm implemented by the computing device 100 (shown in FIGS. 1 and 2) including the processor 20. Further, the process 600 may be stored in the memory 22 as instructions executable by the processor 20. In some cases, the process 600 may be part of the instructions 26 stored in the memory 22.

For filtering the labelled data 74, the processor 20 is further capable of executing the instructions 26 to remove a portion of the labelled data 74 that is not associated with a pipetting probe (not shown). At operation 602, the process 600 starts. Referring to FIGS. 1, 2, 4, 14, and 15, at operation 604, the processor 20 removes the portion of the labelled data 74 that is not associated with the pipetting probe. In other words, the processor 20 removes the portion of the labelled data 74 which is not related to pipetting operations (aspirating/dispensing operations). The removed portion of the labelled data 74 may be associated with other operations in an analyzer, such as transfer procedures, measuring operations, rack loading, colorimetric analysis in reaction vessel, and so on. The process 600 further moves to operation 606.

For filtering the labelled data 74, the processor 20 is further capable of executing the instructions 26 to remove a portion of the labelled data 74 that is simulated. At the operation 606, the processor 20 removes the portion of the labelled data 74 that is simulated. In some testing procedures, output signals of one or more measurement sensors (e.g., the at least one measurement sensor 106) are simulated. The portion of the labelled data 74 including simulated output signals needs to be removed to prevent use of any impractical or improper aspirating/dispensing operations for training the neural network model 24. The process 600 further moves to operation 608.

For filtering the labelled data 74, the processor 20 is further capable of executing the instructions 26 to remove a portion of the labelled data 74 that is not associated with a reagent in an aspirating/dispensing operation. At the operation 608, the processor 20 removes the portion of the labelled data 74 that is not associated with a reagent in an aspirating/dispensing operation. The removed portion of the labelled data 74 may be associated with other liquid handling procedures, such as aspirating/dispensing a wash buffer solution, or a diluent. The process 600 further moves to operation 610 where the process 600 is terminated.

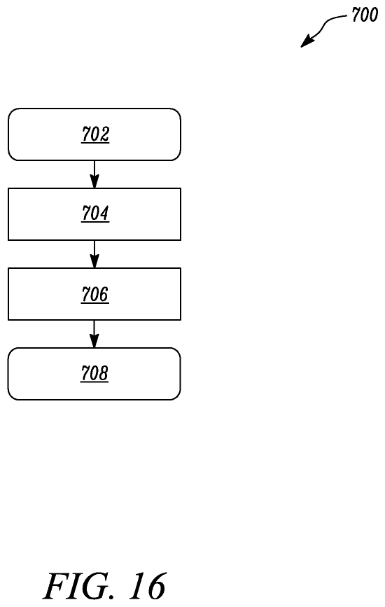

FIG. 16 is a flowchart of a process 700 for filtering the labelled data 74 (shown in FIG. 14), according to an embodiment of the present disclosure. The process 700 is embodied as a machine learning algorithm implemented by the computing device 100 (shown in FIGS. 1 and 2) including the processor 20. Further, the process 700 may be stored in the memory 22 as instructions executable by the processor 20. In some cases, the process 700 may be part of the instructions 26 stored in the memory 22.

At operation 702, the process 700 starts. Referring to FIGS. 1, 2, 4, 14 and 16, for filtering the labelled data 74, the processor 20 is further capable of executing the instructions 26 to remove a portion of the labelled data 74 labelled as normal for which a value of the sensor signal 108 (shown in FIGS. 1 and 2) is not changing with time. At operation 704, the processor 20 removes the portion of the labelled data 74 labelled as normal for which the value of the sensor signal 108 is not changing with time. Also, with reference to the graph 38 of FIG. 3C, there is minimum pressure fluctuation (i.e., a variation of the sensor signal 108 with time) in case of the empty aspirating operation. Therefore, the portion of the labelled data 74 for which the value of the sensor signal 108 is not changing with time may be falsely labelled as normal in the plurality of aspirating/dispensing operations. Hence, for filtering the labelled data 74, the processor 20 removes the portion of the labelled data 74 for which the sensor signal 108 is not changing with time. For example, the processor 20 removes the data corresponding to the graph 38 shown in FIG. 3C. The process 700 further moves to operation 706.

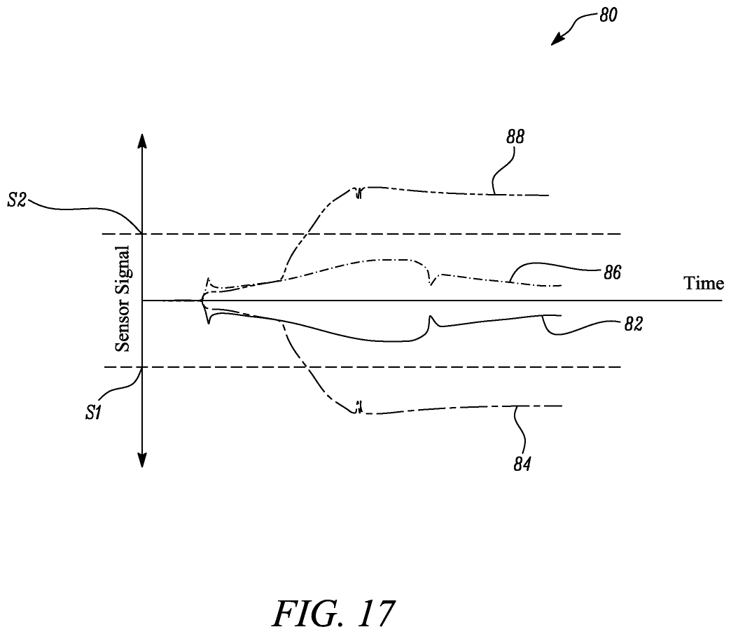

FIG. 17 is an exemplary graph 80 illustrating a variation in the sensor signal 108 with time for aspirating/dispensing operations. Referring to the graph 80, a curve 82 depicts a variation in the sensor signal 108 for a normal aspirating operation. A curve 86 depicts a variation in the sensor signal 108 for a normal dispensing operation. A curve 84 depicts a variation in the sensor signal 108 for an obstructed aspirating operation. A curve 88 depicts a variation in the sensor signal 108 for an obstructed dispensing operation. For the obstructed aspirating operation and the obstructed dispensing operation, each of the curves 84, 88 cross one of an upper signal value S2 and a lower signal value S1. Specifically, the curve 84 corresponding to the obstructed aspirating operation crosses the lower signal value S1. Further, the curve 88 corresponding to the obstructed dispensing operation crosses the upper signal value S2.

Referring to FIGS. 1, 2, 4, 14, 16, and 17, for filtering the labelled data 74, the processor 20 is further capable of executing the instructions 26 to remove a portion of the labelled data 74 labelled as normal for which the value of the sensor signal 108 crosses one of the upper signal value S2 and the lower signal value S1. At the operation 706, the processor 20 removes the portion of the labelled data 74 labelled as normal for which the value of the sensor signal 108 crosses one of the upper signal value S2 and the lower signal value S1. For example, the processor 20 removes the data corresponding to the curves 84, 88 shown in FIG. 17. The process 700 further moves to operation 708 where the process 700 is terminated.

Referring to FIGS. 1, 2, 4, 14, 15, and 16, for training the neural network model 24 implemented by the computing device 100, the prior data 72 is collected and labelled with the plurality of classifications. The labelled data 74 is further filtered and then normalized to generate the training data 78 configured to be used for training the neural network model 24. In some cases, filtering of the labelled data 74 includes various steps, such as removing the portion of the labelled data 74 that is not associated with a pipetting device, removing the portion of the labelled data 74 that is simulated, and removing the portion of the labelled data 74 that is not associated with the reagent in the aspirating/dispensing operations. In some other cases, filtering of the labelled data 74 includes various steps, such as removing the portion of the labelled data 74 labelled as normal for which the value of the sensor signal 108 is not changing with time and removing the portion of the labelled data 74 labelled as normal for which the value of the sensor signal 108 crosses one of the upper signal value S2 and the lower signal value S1. All these steps of filtering the labelled data 74 before the training of the neural network model 24 may ultimately decrease a processing time required by the processor 20 for implementing the neural network model 24. This may further improve an efficiency of the automated analyzer 50.

In some cases, the neural network model 24 may comprise a Gaussian noise layer that adds noise to the input values from the training data 78 when the neural network model 24 is trained. The Gaussian noise layer takes the input values from the input layer (302) and outputs the input values with added noise.

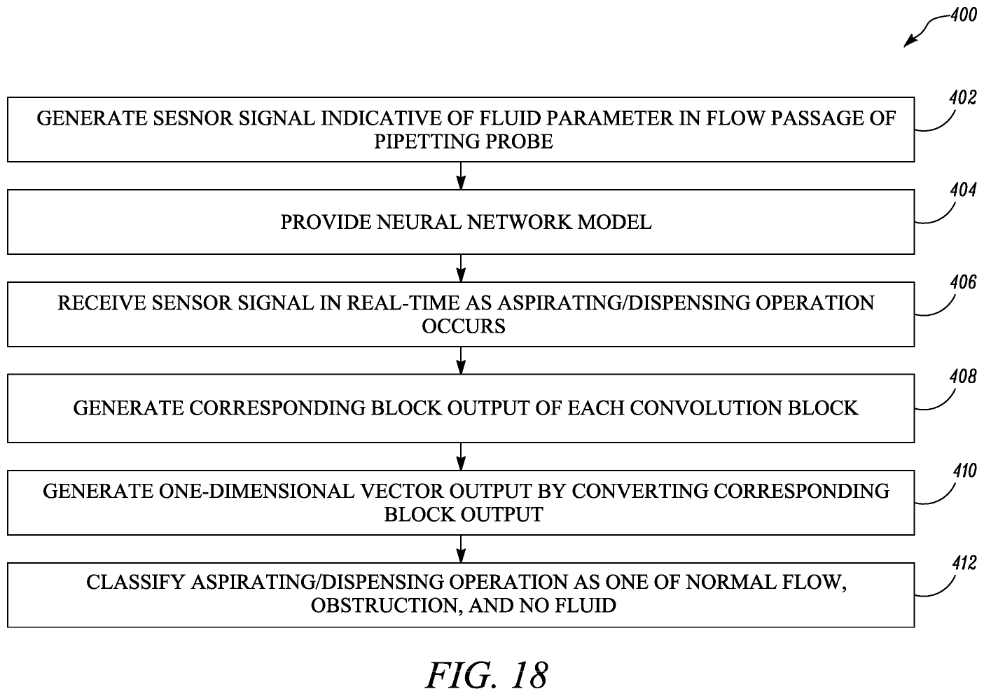

FIG. 18 is a flowchart illustrating a method 400 of classification of the aspirating/dispensing operation in the automated analyzer 50 (shown in FIGS. 1 and 2), according to an embodiment of the present disclosure. The method 400 includes operations 402, 404, 406, 408, 410, and 412.

Referring to FIGS. 1, 2, 4, and 18, at operation 402, the at least one measurement sensor 106 generates the sensor signal 108 indicative of the fluid parameter in the flow passage 105 of the pipetting probe 104 used in the aspirating/dispensing operation. At operation 404, the processor 20 executes the instructions 26 to provide or activate the neural network model 24.

At operation 406, the input layer 302 receives the sensor signal 108 in real-time as the aspirating/dispensing operation occurs. At operation 408, each of the plurality of convolution blocks 202-1, 202-2 . . . 202-N generates the corresponding block output 204-1, 204-2 . . . 204-N. At operation 410, the flatten layer 318 generates the one-dimensional vector output 64 by converting the corresponding block output (i.e., the last block output 204-N) received from the previous convolution block (i.e., the last convolution block 202-N). At operation 412, the probability layer 320 classifies the aspirating/dispensing operation as one of normal, obstructed, and empty by using the one-dimensional vector output 64 received from the flatten layer 318.

In some embodiments, the method 400 further includes generating the flag upon classification of the aspirating/dispensing operation as obstructed or empty. Further, the method may include stopping the ongoing analysis process upon generation of the flag.

Referring to FIGS. 1, 2, 4, 14, and 18, the method 400 further includes generating the training data 78 (shown in FIG. 14) for training the neural network model 24. Generating the training data 78 further includes collecting the prior data 72 (shown in FIG. 14) associated with the plurality of aspirating/dispensing operations. Generating the training data 78 further includes labelling the prior data 72 with the plurality of classifications to generate the labelled data 74 (shown in FIG. 14). Generating the training data 78 further includes filtering the labelled data 74 to generate the filtered data 76 (shown in FIG. 14). Generating the training data 78 further includes normalizing the filtered data 76 based on the one or more parameters to generate the training data 78.

Referring to FIGS. 1, 2, 4, 14, 15, and 18, filtering the labelled data 74 further includes removing the portion of the labelled data 74 that is not associated with a pipetting probe. Filtering the labelled data 74 further includes removing the portion of the labelled data 74 that is simulated. Filtering the labelled data 74 further includes removing the portion of the labelled data 74 that is not associated with a reagent in an aspirating/dispensing operation.

Referring to FIGS. 1, 2, 4, 14, 16, 17, and 18, filtering the labelled data 74 further includes removing the portion of the labelled data 74 labelled as normal flow for which the value of the sensor signal 108 is not changing with time. Filtering the labelled data 74 further includes removing the portion of the labelled data 74 labelled as normal flow for which the value of the sensor signal 108 crosses one of the upper signal value S2 and the lower signal value S1.

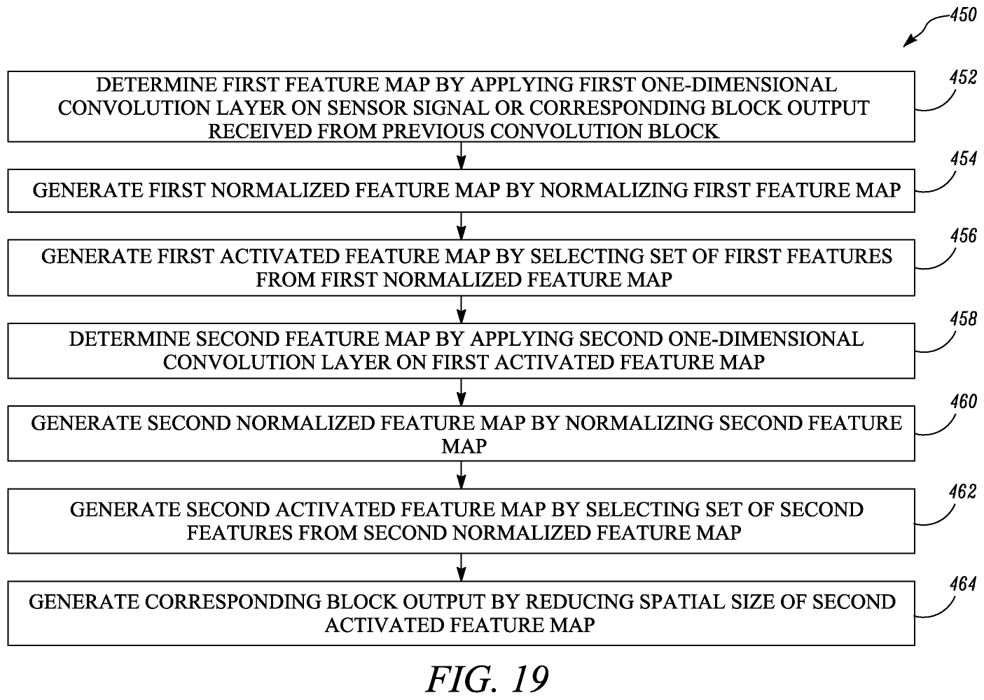

FIG. 19 is a flowchart illustrating a method 450 of generating, via each of the plurality of convolution blocks 202-1, 202-2 . . . 202-N (shown in FIG. 4), the corresponding block output 204-1, 204-2 . . . 204-N in the neural network model 24 (shown in FIG. 4), according to an embodiment of the present disclosure. The method 400 includes operations 452, 454, 456, 458, 460, 462, and 464.

Referring to FIGS. 1, 4, and 19, at operation 452, the first one-dimensional convolution layer 304-1, 304-2 . . . 304-N determines the corresponding first feature map 52-1, 52-2 . . . 52-N. Specifically, generating the corresponding block output 204-1, 204-2 . . . 204-N includes determining the first feature map 52-1, 52-2 . . . 52-N by applying the first one-dimensional convolution layer 304-1, 304-2 . . . 304-N on the sensor signal 108 received from the input layer 302 or the corresponding block output 204-1, 204-2 . . . 204-N-1 received from the previous convolution block 202-1, 202-2 . . . 202-N-1 from the plurality of convolution blocks 202-1, 202-2 . . . 202-N.

At operation 454, the first batch normalization layer 306-1, 306-2 . . . 306-N generates the corresponding first normalized feature map 54-1, 54-2 . . . 54-N. Specifically, generating the corresponding block output 204-1, 204-2 . . . 204-N further includes generating, via the first batch normalization layer 306-1, 306-2 . . . 306-N, the first normalized feature map 54-1, 54-2 . . . 54-N by normalizing the first feature map 52-1, 52-2 . . . 52-N received from the first one-dimensional convolution layer 304-1, 304-2 . . . 304-N.

At operation 456, the first activation layer 308-1, 308-2 . . . 308-N generates the corresponding first activated feature map 56-1, 56-2 . . . 56-N. Specifically, generating the corresponding block output 204-1, 204-2 . . . 204-N further includes generating, via the first activation layer 308-1, 308-2 . . . 308-N, the first activated feature map 56-1, 56-2 . . . 56-N by selecting the set of first features from the first normalized feature map 54-1, 54-2 . . . 54-N received from the first batch normalization layer 306-1, 306-2 . . . 306-N.

At operation 458, the second one-dimensional convolution layer 310-1, 310-2 . . . 310-N determines the corresponding second feature map 58-1, 58-2 . . . 58-N. Specifically, generating the corresponding block output 204-1, 204-2 . . . 204-N further includes determining the second feature map 58-1, 58-2 . . . 58-N by applying the second one-dimensional convolution layer 310-1, 310-2 . . . 310-N on the first activated feature map 56-1, 56-2 . . . 56-N received from the first activation layer 308-1, 308-2 . . . 308-N.

At operation 460, the second batch normalization layer 312-1, 312-2 . . . 312-N generates the corresponding second normalized feature map 60-1, 60-2 . . . 60-N. Specifically, generating the corresponding block output 204-1, 204-2 . . . 204-N further includes generating, via the second batch normalization layer 312-1, 312-2 . . . 312-N, the second normalized feature map 60-1, 60-2 . . . 60-N by normalizing the second feature map 58-1, 58-2 . . . 58-N received from the second one-dimensional convolution layer 310-1, 310-2 . . . 310-N.

At operation 462, the second activation layer 314-1, 314-2 . . . 314-N generates the corresponding second activated feature map 62-1, 62-2 . . . 62-N. Specifically, generating the corresponding block output 204-1, 204-2 . . . 204-N further includes generating, via the second activation layer 314-1, 314-2 . . . 314-N, the second activated feature map 62-1, 62-2 . . . 62-N by selecting the set of second features from the second normalized feature map 60-1, 60-2 . . . 60-N received from the second batch normalization layer 312-1, 312-2 . . . 312-N.

At operation 464, the pooling layer 316-1, 316-2 . . . 316-N generates the corresponding block output 204-1, 204-2 . . . 204-N by reducing the spatial size of the second activated feature map 62-1, 62-2 . . . 62-N received from the second activation layer 314-1, 314-2 . . . 314-N.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

In view of the above, the present application discloses aspects and/or embodiments of the invention as described in the following itemized list:
1. An automated analyzer (50) comprising:
   a pipetting device (102) comprising a pipetting probe (104) configured to conduct an aspirating/dispensing operation;
   at least one measurement sensor (106) associated with the pipetting probe (104), wherein the at least one measurement sensor (106) is configured to generate a sensor signal (108) indicative of a fluid parameter in a flow passage (105) of the pipetting probe (104);
   a memory (22) storing a neural network model (24), wherein the neural network model (24) sequentially comprises an input layer (302), a plurality of convolution blocks (202-1, 202-2 . . . 202-N), a flatten layer (318), and a probability layer (320), wherein each of the plurality of convolution blocks (202-1, 202-2 . . . 202-N) sequentially comprises a first one-dimensional convolution layer (304-1, 304-2 . . . 304-N), a first batch normalization layer (306-1, 306-2 . . . 306-N), a first activation layer (308-1, 308-2 . . . 308-N), a second one-dimensional convolution layer (310-1, 310-2 . . . 310-N), a second batch normalization layer (312-1, 312-2 . . . 312-N), a second activation layer (314-1, 314-2 . . . 314-N), and a pooling layer (316-1, 316-2 . . . 316-N); and
   a processor (20) communicably coupled to the at least one measurement sensor (106) and the memory (22), wherein the processor (20) is capable of implementing the neural network model (24), wherein the processor (20) is further capable of executing instructions (26) to:
      receive, via the input layer (302), the sensor signal (108) in real-time as the aspirating/dispensing operation occurs;
      generate, via each of the plurality of convolution blocks (202-1, 202-2 . . . 202-N), a corresponding block output (204-1, 204-2 . . . 204-N), wherein, for generating the corresponding block output (204-1, 204-2 . . . 204-N), the processor (20) is further capable of executing instructions (26) to:
         determine a first feature map (52-1, 52-2 . . . 52-N) by applying the first one-dimensional convolution layer (304-1, 304-2 . . . 304-N) on the sensor signal (108) received from the input layer (302) or the corresponding block output (204-1, 204-2 . . . 204-N-1) received from a previous convolution block (202-1, 202-2 . . . 202-N-1) from the plurality of convolution blocks (202-1, 202-2 . . . 202-N);
         generate, via the first batch normalization layer (306-1, 306-2 . . . 306-N), a first normalized feature map (54-1, 54-2 . . . 54-N) by normalizing the first feature map (52-1, 52-2 . . . 52-N) received from the first one-dimensional convolution layer (304-1, 304-2 . . . 304-N);
         generate, via the first activation layer (308-1, 308-2 . . . 308-N), a first activated feature map (56-1, 56-2 . . . 56-N) by selecting a set of first features from the first normalized feature map (54-1, 54-2 . . . 54-N) received from the first batch normalization layer (306-1, 306-2 . . . 306-N);
         determine a second feature map (58-1, 58-2 . . . 58-N) by applying the second one-dimensional convolution layer (310-1, 310-2 . . . 310-N) on the first activated feature map (56-1, 56-2 . . . 56-N) received from the first activation layer (308-1, 308-2 . . . 308-N);
         generate, via the second batch normalization layer (312-1, 312-2 . . . 312-N), a second normalized feature map (60-1, 60-2 . . . 60-N) by normalizing the second feature map (58-1, 58-2 . . . 58-N) received from the second one-dimensional convolution layer (310-1, 310-2 . . . 310-N);
         generate, via the second activation layer (314-1, 314-2 . . . 314-N), a second activated feature map (62-1, 62-2 . . . 62-N) by selecting a set of second features from the second normalized feature map (60-1, 60-2 . . . 60-N) received from the second batch normalization layer (312-1, 312-2 . . . 312-N); and
         generate, via the pooling layer (316-1, 316-2 . . . 316-N), the corresponding block output (204-1, 204-2 . . . 204-N) by reducing a spatial size of the second activated feature map (62-1, 62-2 . . . 62-N) received from the second activation layer (314-1, 314-2 . . . 314-N);
      generate, via the flatten layer (318), a one-dimensional vector output (64) by converting the corresponding block output (204-N) received from the previous convolution block (202-N); and
      classify, via the probability layer (320), the aspirating/dispensing operation as one of a normal flow, an obstruction, and no fluid by using the one-dimensional vector output (64) received from the flatten layer (318).
2. The automated analyzer (50) of item 1, wherein the processor (20) is further capable of executing instructions (26) to generate a flag upon classification of the aspirating/dispensing operation as an obstruction or no fluid.
3. The automated analyzer (50) of any of items 1 or 2, wherein:
   the first one-dimensional convolution layer (304-1, 304-2 . . . 304-N) of each of the plurality of convolution blocks (202-1, 202-2 . . . 202-N) comprises a plurality of first parameters (P1-1, P1-2 . . . . P1-N); and
   the second one-dimensional convolution layer (310-1, 310-2 . . . 310-N) of each of the plurality of convolution blocks (202-1, 202-2 . . . 202-N) comprises a plurality of second parameters (P2-1, P2-2 . . . . P2-N), a number of the plurality of second parameters (P2-1, P2-2 . . . . P2-N) being greater than or equal to a number of the plurality of first parameters (P1-1, P1-2 . . . . P1-N).
4. The automated analyzer (50) of item 3, wherein the plurality of convolution blocks (202-1, 202-2 . . . 202-N) sequentially comprises a first convolution block (202-1) receiving the sensor signal (108) from the input layer (302), one or more intermediate convolution blocks (202-2, 202-3 . . . 202-N-1), and a last convolution block (202-N) providing the corresponding block output (204-N) to the flatten layer (318).
5. The automated analyzer (50) of item 4, wherein, for the first convolution block (202-1), the number of the plurality of second parameters (P2-1) is greater than the number of the plurality of first parameters (P1-1) by a factor of at least 50.
6. The automated analyzer (50) of any of items 4 or 5, wherein, for each of the one or more intermediate convolution blocks (202-2, 202-3 . . . 202-N-1), the number of the plurality of second parameters (P2-2, P2-3 . . . . P2-N-1) is equal to the number of the plurality of first parameters (P1-2, P1-3 . . . . P1-N-1).
7. The automated analyzer (50) of any of items 4 to 6, wherein, for the last convolution block (202-N), the number of the plurality of second parameters (P2-N) is equal to the number of the plurality of first parameters (P1-N).
8. The automated analyzer (50) of any of items 1 to 7, wherein the at least one measurement sensor (106) is a pressure sensor, and wherein the flow parameter is pressure.
9. The automated analyzer (50) of any of items 1 to 8, wherein the sensor signal (108) is a voltage signal.
10. The automated analyzer (50) of any of items 1 to 9, wherein the processor (20) is further capable of executing instructions (26) to generate training data (78) for training the neural network model (24), and wherein, for generating the training data (78), the processor (20) is further capable of executing instructions (26) to:
   collect prior data (72) associated with a plurality of aspirating/dispensing operations;
   label the prior data (72) with a plurality of classifications to generate labelled data (74), wherein each of the plurality of classifications is associated with a corresponding aspirating/dispensing operation from the plurality of aspirating/dispensing operations, and wherein each of the plurality of classifications is one of a normal flow, an obstruction, and no fluid;
   filter the labelled data (74) to generate filtered data (76); and
   normalize the filtered data (76) based on one or more parameters to generate the training data (78).
11. The automated analyzer (50) of item 10, wherein, for filtering the labelled data (74), the processor (20) is further capable of executing instructions (26) to:
   remove a portion of the labelled data (74) that is not associated with a pipetting probe;
   remove a portion of the labelled data (74) that is simulated; and
   remove a portion of the labelled data (74) that is not associated with a reagent in an aspirating/dispensing operation.
12. The automated analyzer (50) of any of items 10 or 11, wherein, for filtering the labelled data (74), the processor (20) is further capable of executing instructions (26) to:
   remove a portion of the labelled data (74) labelled as normal flow for which a value of the sensor signal (108) is not changing with time; and
   remove a portion of the labelled data (74) labelled as normal flow for which the value of the sensor signal (108) crosses one of an upper signal value (S2) and a lower signal value (S1).
13. A method (400) of classification of an aspirating/dispensing operation in an automated analyzer (50), the method (400) comprising:
   generating, by at least one measurement sensor (106), a sensor signal (108) indicative of a fluid parameter in a flow passage (105) of a pipetting probe (104) used in the aspirating/dispensing operation;
   providing a neural network model (24) sequentially comprising an input layer (302), a plurality of convolution blocks (202-1, 202-2 . . . 202-N), a flatten layer (318), and a probability layer (320), wherein each of the plurality of convolution blocks (202-1, 202-2 . . . 202-N) sequentially comprises a first one-dimensional convolution layer (304-1, 304-2 . . . 304-N), a first batch normalization layer (306-1, 306-2 . . . 306-N), a first activation layer (308-1, 308-2 . . . 308-N), a second one-dimensional convolution layer (310-1, 310-2 . . . 310-N), a second batch normalization layer (312-1, 312-2 . . . 312-N), a second activation layer (314-1, 314-2 . . . 314-N), and a pooling layer (316-1, 316-2 . . . 316-N);
   receiving, via the input layer (302), the sensor signal (108) in real-time as the aspirating/dispensing operation occurs;
   generating, via each of the plurality of convolution blocks (202-1, 202-2 . . . 202-N), a corresponding block output (204-1, 204-2 . . . 204-N), wherein generating the corresponding block output (204-1, 204-2 . . . 204-N) further comprises:
      determining a first feature map (52-1, 52-2 . . . 52-N) by applying the first one-dimensional convolution layer (304-1, 304-2 . . . 304-N) on the sensor signal (108) received from the input layer (302) or the corresponding block output (204-1, 204-2 . . . 204-N-1) received from a previous convolution block (202-1, 202-2 . . . 202-N-1) from the plurality of convolution blocks (202-1, 202-2 . . . 202-N);
      generating, via the first batch normalization layer (306-1, 306-2 . . . 306-N), a first normalized feature map (54-1, 54-2 . . . 54-N) by normalizing the first feature map (52-1, 52-2 . . . 52-N) received from the first one-dimensional convolution layer (304-1, 304-2 . . . 304-N);
      generating, via the first activation layer (308-1, 308-2 . . . 308-N), a first activated feature map (56-1, 56-2 . . . 56-N) by selecting a set of first features from the first normalized feature map (54-1, 54-2 . . . 54-N) received from the first batch normalization layer (306-1, 306-2 . . . 306-N);
      determining a second feature map (58-1, 58-2 . . . 58-N) by applying the second one-dimensional convolution layer (310-1, 310-2 . . . 310-N) on the first activated feature map (56-1, 56-2 . . . 56-N) received from the first activation layer (308-1, 308-2 . . . 308-N);
      generating, via the second batch normalization layer (312-1, 312-2 . . . 312-N), a second normalized feature map (60-1, 60-2 . . . 60-N) by normalizing the second feature map (58-1, 58-2 . . . 58-N) received from the second one-dimensional convolution layer (310-1, 310-2 . . . 310-N);
      generating, via the second activation layer (314-1, 314-2 . . . 314-N), a second activated feature map (62-1, 62-2 . . . 62-N) by selecting a set of second features from the second normalized feature map (60-1, 60-2 . . . 60-N) received from the second batch normalization layer (312-1, 312-2 . . . 312-N); and
      generating, via the pooling layer (316-1, 316-2 . . . 316-N), the corresponding block output (204-1, 204-2 . . . 204-N) by reducing a spatial size of the second activated feature map (62-1, 62-2 . . . 62-N) received from the second activation layer (314-1, 314-2 . . . 314-N);
   generating, via the flatten layer (318), a one-dimensional vector output (64) by converting the corresponding block output (204-N) received from the previous convolution block (202-N); and
   classifying, via the probability layer (320), the aspirating/dispensing operation as one of a normal flow, an obstruction, and no fluid by using the one-dimensional vector output (64) received from the flatten layer (318).
14. The method (400) of item 13, further comprising generating a flag upon classification of the aspirating/dispensing operation as an obstruction or no fluid.
15. The method (400) of any of items 13 or 14, wherein:
   the first one-dimensional convolution layer (304-1, 304-2 . . . 304-N) of each of the plurality of convolution blocks (202-1, 202-2 . . . 202-N) comprises a plurality of first parameters (P1-1, P1-2 . . . . P1-N); and
   the second one-dimensional convolution layer (310-1, 310-2 . . . 310-N) of each of the plurality of convolution blocks (202-1, 202-2 . . . 202-N) comprises a plurality of second parameters (P2-1, P2-2 . . . . P2-N), a number of the plurality of second parameters (P2-1, P2-2 . . . P2-N) being greater than or equal to a number of the plurality of first parameters (P1-1, P1-2 . . . . P1-N).
16. The method (400) of item 15, wherein the plurality of convolution blocks (202-1, 202-2 . . . 202-N) sequentially comprises a first convolution block (202-1) receiving the sensor signal (108) from the input layer (302), one or more intermediate convolution blocks (202-2, 202-3 . . . 202-N-1), and a last convolution block (202-N) providing the corresponding block output (204-N) to the flatten layer (318).
17. The method (400) of item 16, wherein, for the first convolution block (202-1), the number of the plurality of second parameters (P2-1) is greater than the number of the plurality of first parameters (P1-1) by a factor of at least 50.
18. The method (400) of any of items 16 or 17, wherein, for each of the one or more intermediate convolution blocks (202-2, 202-3 . . . 202-N-1), the number of the plurality of second parameters (P2-2, P2-3 . . . . P2-N-1) is equal to the number of the plurality of first parameters (P1-2, P1-3 . . . . P1-N-1).
19. The method (400) of any of items 16 to 18, wherein, for the last convolution block (202-N), the number of the plurality of second parameters (P2-N) is equal to the number of the plurality of first parameters (P1-N).
20. The method (400) of any of items 13 to 19, wherein the at least one measurement sensor (106) is a pressure sensor, and wherein the flow parameter is pressure.
21. The method (400) of any of items 13 to 20, wherein the sensor signal (108) is a voltage signal.
22. The method (400) of any of items 13 to 21, further comprises generating training data (78) for training the neural network model (24), wherein generating the training data (78) comprises:
   collecting prior data (72) associated with a plurality of aspirating/dispensing operations;
   labelling the prior data (72) with a plurality of classifications to generate labelled data (74), wherein each of the plurality of classifications is associated with a corresponding aspirating/dispensing operation from the plurality of aspirating/dispensing operations, and wherein each of the plurality of classifications is one of a normal flow, an obstruction, and no fluid;
   filtering the labelled data (74) to generate filtered data (76); and normalizing the filtered data (76) based on one or more parameters to generate the training data (78).
23. The method (400) of item 22, wherein filtering the labelled data (74) further comprises:
   removing a portion of the labelled data (74) that is not associated with a pipetting probe;
   removing a portion of the labelled data (74) that is simulated; and
   removing a portion of the labelled data (74) that is not associated with a reagent in an aspirating/dispensing operation.
24. The method (400) of any of items 22 or 23, wherein filtering the labelled data (74) further comprises:
   removing a portion of the labelled data (74) labelled as normal flow for which a value of the sensor signal (108) is not changing with time; and
   removing a portion of the labelled data (74) labelled as normal flow for which the value of the sensor signal (108) crosses one of an upper signal value (S2) and a lower signal value (S1).
25. A computing device (100) for classification of an aspirating/dispensing operation in an automated analyzer (50), the computing device (100) comprising:
   a memory (22) storing a neural network model (24), wherein the neural network sequentially comprises an input layer (302), a plurality of convolution blocks (202-1, 202-2 . . . 202-N), a flatten layer (318), and a probability layer (320), wherein each of the plurality of convolution blocks (202-1, 202-2 . . . 202-N) sequentially comprises a first one-dimensional convolution layer (304-1, 304-2 . . . 304-N), a first batch normalization layer (306-1, 306-2 . . . 306-N), a first activation layer (308-1, 308-2 . . . 308-N), a second one-dimensional convolution layer (310-1, 310-2 . . . 310-N), a second batch normalization layer (312-1, 312-2 . . . 312-N), a second activation layer (314-1, 314-2 . . . 314-N), and a pooling layer (316-1, 316-2 . . . 316-N); and
   a processor (20) communicably coupled to the memory (22) and at least one measurement sensor (106) associated with a pipetting probe (104) of a pipetting device (102), wherein the processor (20) is capable of implementing the neural network model (24), wherein the processor (20) is further capable of executing instructions (26) to:
      receive, via the input layer (302), a sensor signal (108) generated by the at one measurement sensor (106) in real-time as the aspirating/dispensing operation occurs, wherein the sensor signal (108) is indicative of a fluid parameter in a flow passage (105) of the pipetting probe (104);
      generate, via each of the plurality of convolution blocks (202-1, 202-2 . . . 202-N), a corresponding block output (204-1, 204-2 . . . 204-N), wherein, for generating the corresponding block output (204-1, 204-2 . . . 204-N), the processor (20) is further capable of executing instructions (26) to:
         determine a first feature map (52-1, 52-2 . . . 52-N) by applying the first one-dimensional convolution layer (304-1, 304-2 . . . 304-N) on the sensor signal (108) received from the input layer (302) or the corresponding block output (204-1, 204-2 . . . 204-N-1) received from a previous convolution block (202-1, 202-2 . . . 202-N-1) from the plurality of convolution blocks (202-1, 202-2 . . . 202-N);
         generate, via the first batch normalization layer (306-1, 306-2 . . . 306-N), a first normalized feature map (54-1, 54-2 . . . 54-N) by normalizing the first feature map (52-1, 52-2 . . . 52-N) received from the first one-dimensional convolution layer (304-1, 304-2 . . . 304-N);
         generate, via the first activation layer (308-1, 308-2 . . . 308-N), a first activated feature map (56-1, 56-2 . . . 56-N) by selecting a set of first features from the first normalized feature map (54-1, 54-2 . . . 54-N) received from the first batch normalization layer (306-1, 306-2 . . . 306-N);
         determine a second feature map (58-1, 58-2 . . . 58-N) by applying the second one-dimensional convolution layer (310-1, 310-2 . . . 310-N) on the first activated feature map (56-1, 56-2 . . . 56-N) received from the first activation layer (308-1, 308-2 . . . 308-N);
         generate, via the second batch normalization layer (312-1, 312-2 . . . 312-N), a second normalized feature map (60-1, 60-2 . . . 60-N) by normalizing the second feature map (58-1, 58-2 . . . 58-N) received from the second one-dimensional convolution layer (310-1, 310-2 . . . 310-N);
         generate, via the second activation layer (314-1, 314-2 . . . 314-N), a second activated feature map (62-1, 62-2 . . . 62-N) by selecting a set of second features from the second normalized feature map (60-1, 60-2 . . . 60-N) received from the second batch normalization layer (312-1, 312-2 . . . 312-N); and
         generate, via the pooling layer (316-1, 316-2 . . . 316-N), the corresponding block output (204-1, 204-2 . . . 204-N) by reducing a spatial size of the second activated feature map (62-1, 62-2 . . . 62-N) received from the second activation layer (314-1, 314-2 . . . 314-N);
      generate, via the flatten layer (318), a one-dimensional vector output (64) by converting the corresponding block output (204-N) received from the previous convolution block (202-N); and
      classify, via the probability layer (320), the aspirating/dispensing operation as one of a normal flow, an obstruction, and no fluid by using the one-dimensional vector output (64) received from the flatten layer (318).
26. The computing device (100) of item 25, wherein the processor (20) is further capable of executing instructions (26) to generate a flag upon classification of the aspirating/dispensing operation as an obstruction or no fluid.
27. The computing device (100) of any of items 25 or 26, wherein:
   the first one-dimensional convolution layer (304-1, 304-2 . . . 304-N) of each of the plurality of convolution blocks (202-1, 202-2 . . . 202-N) comprises a plurality of first parameters (P1-1, P1-2 . . . . P1-N); and
   the second one-dimensional convolution layer (310-1, 310-2 . . . 310-N) of each of the plurality of convolution blocks (202-1, 202-2 . . . 202-N) comprises a plurality of second parameters (P2-1, P2-2 . . . . P2-N), a number of the plurality of second parameters (P2-1, P2-2 . . . P2-N) being greater than or equal to a number of the plurality of first parameters (P1-1, P1-2 . . . . P1-N).
28. The computing device (100) of item 27, wherein the plurality of convolution blocks (202-1, 202-2 . . . 202-N) sequentially comprises a first convolution block (202-1) receiving the sensor signal (108) from the input layer (302), one or more intermediate convolution blocks (202-2, 202-3 . . . 202-N-1), and a last convolution block (202-N) providing the corresponding block output (204-N) to the flatten layer (318).
29. The computing device (100) of item 28, wherein, for the first convolution block (202-1), the number of the plurality of second parameters (P2-1) is greater than the number of the plurality of first parameters (P1-1) by a factor of at least 50.
30. The computing device (100) of any of items 28 or 29, wherein, for each of the one or more intermediate convolution blocks (202-2, 202-3 . . . 202-N-1), the number of the plurality of second parameters (P2-2, P2-3 . . . . P2-N-1) is equal to the number of the plurality of first parameters (P1-2, P1-3 . . . . P1-N-1).
31. The computing device (100) of any of items 28 to 30, wherein, for the last convolution block (202-N), the number of the plurality of second parameters (P2-N) is equal to the number of the plurality of first parameters (P1-N).
32. The computing device (100) of any of items 25 to 31, wherein the at least one measurement sensor (106) is a pressure sensor, and wherein the flow parameter is pressure.
33. The computing device (100) of any of items 25 to 32, wherein the sensor signal (108) is a voltage signal.
34. The computing device (100) of any of items 25 to 33, wherein the processor (20) is further capable of executing instructions (26) to generate training data (78) for training the neural network model (24), and wherein, for generating the training data (78), the processor (20) is further capable of executing instructions (26) to:
   collect prior data (72) associated with a plurality of aspirating/dispensing operations;
   label the prior data (72) with a plurality of classifications to generate labelled data (74), wherein each of the plurality of classifications is associated with a corresponding aspirating/dispensing operation from the plurality of aspirating/dispensing operations, and wherein each of the plurality of classifications is one of a normal flow, an obstruction, and no fluid;
   filter the labelled data (74) to generate filtered data (76); and
   normalize the filtered data (76) based on one or more parameters to generate the training data (78).
35. The computing device (100) of item 34, wherein, for filtering the labelled data (74), the processor (20) is further capable of executing instructions (26) to:
   remove a portion of the labelled data (74) that is not associated with a pipetting probe;
   remove a portion of the labelled data (74) that is simulated; and
   remove a portion of the labelled data (74) that is not associated with a reagent in an aspirating/dispensing operation.
36. The computing device (100) of any of items 34 or 35, wherein, for filtering the labelled data (74), the processor (20) is further capable of executing instructions (26) to:
   remove a portion of the labelled data (74) labelled as normal flow for which a value of the sensor signal (108) is not changing with time; and
   remove a portion of the labelled data (74) labelled as normal flow for which the value of the sensor signal (108) crosses one of an upper signal value (S2) and a lower signal value (S1).

1. An automated analyzer (50) comprising:
a pipetting device (102) comprising a pipetting probe (104) configured to conduct an aspirating/dispensing operation;
at least one measurement sensor (106) associated with the pipetting probe (104), wherein the at least one measurement sensor (106) is configured to generate a sensor signal (108) indicative of a fluid parameter in a flow passage (105) of the pipetting probe (104);
a memory (22) storing a neural network model (24), wherein the neural network model (24) comprises a plurality of convolution blocks (202-1, 202-2 . . . 202-N), wherein each of the plurality of convolution blocks (202-1, 202-2 . . . 202-N) comprises a first one-dimensional convolution layer (304-1, 304-2 . . . 304-N) and a second one-dimensional convolution layer (310-1, 310-2 . . . 310-N); and
a processor (20) communicably coupled to the at least one measurement sensor (106) and the memory (22);
wherein:
the neural network model (24) is configure to classify, based on the sensor signal (108), the aspirating/dispensing operation into a class of a plurality of classes, the plurality of classes comprising at least one correct class and at least one incorrect class; and
the processor (20) is capable of executing the neural network model (24).

2. The automated analyzer of claim 1, wherein the plurality of classes comprise a first incorrect class indicating an obstructed aspirating/dispensing operation and a second incorrect class indicating an empty aspirating/dispensing operation.

3. The automated analyzer of claim 1 or 2, wherein the at least one measurement sensor is an uncalibrated sensor.

4. The automated analyzer of any one of claims 1 to 3, wherein the neural network model (24) is configured to classify the aspirating/dispensing operation based on only the sensor signal (108).

5. The automated analyzer of any one of claims 1 to 4, wherein the neural network model (24) further comprises an input layer (302) and a noise layer between the input layer (302) and a first convolution block of the plurality of convolution blocks (202-1, 202-2 . . . 202-N).

6. The automated analyzer of any one of claims 1 to 5, wherein the processor is further capable of executing instructions to generate a flag upon classification of the aspirating/dispensing operation in the at least one incorrect class.

7. The automated analyzer of claim 6, wherein the processor is further capable of executing instructions to suspend an analysis process upon generation of the flag.

8. The automated analyzer of any one of claims 1 to 7, wherein the at least one measurement sensor is a pressure sensor, and the flow parameter is pressure.

9. A method (400) of classification of an aspirating/dispensing operation in an automated analyzer (50) comprising a pipetting probe (104), the method (400) comprising:
generating, by at least one measurement sensor (106), a sensor signal (108) indicative of a fluid parameter in a flow passage (105) of the pipetting probe (104) used in the aspirating/dispensing operation;
providing a neural network model (24) comprising a plurality of convolution blocks (202-1, 202-2 . . . 202-N), wherein each of the plurality of convolution blocks (202-1, 202-2 . . . 202-N) comprises a first one-dimensional convolution layer (304-1, 304-2 . . . 304-N) and a second one-dimensional convolution layer (310-1, 310-2 . . . 310-N);
and
classifying, via the neural network model (24) and based on the sensor signal (108), the aspirating/dispensing operation into a class of a plurality of classes, the plurality of classes comprising at least one correct class and at least one incorrect class.

10. The method of claim 9, wherein the plurality of classes comprise a first incorrect class indicating an obstructed aspirating/dispensing operation and a second incorrect class indicating an empty aspirating/dispensing operation.

11. The method of claim 9 or 10, wherein the at least one measurement sensor is an uncalibrated sensor.

12. The method of any one of claims 9 to 11, wherein the classifying is based only on the sensor signal (108).

13. The method of any one of claims 9 to 12, wherein the neural network model (24) further comprises an input layer (302) and a noise layer between the input layer (302) and a first convolution block of the plurality of convolution blocks (202-1, 202-2 . . . 202-N) and the method further comprises training the neural network model (24), wherein training the neural network model (24) comprises activating the noise layer.

14. The method of any one of claims 9 to 13, wherein the method further comprises generating a flag upon classification of the aspirating/dispensing operation in the at least one incorrect class.

15. The method of claim 14, wherein the method further comprises suspending an analysis process upon generation of the flag.

16. The method of any one of claims 9 to 15, wherein the at least one measurement sensor is a pressure sensor, and the flow parameter is pressure.

17. A computing device (100) for classification of an aspirating/dispensing operation in an automated analyzer (50), the computing device (100) comprising:
a memory (22) storing a neural network model (24), wherein the neural network comprises a plurality of convolution blocks (202-1, 202-2 . . . 202-N), wherein each of the plurality of convolution blocks (202-1, 202-2 . . . 202-N) comprises a first one-dimensional convolution layer (304-1, 304-2 . . . 304-N) and a second one-dimensional convolution layer (310-1, 310-2 . . . 310-N); and
a processor (20) communicably coupled to the memory (22) and at least one measurement sensor (106) associated with a pipetting probe (104) of the automated analyzer (50), wherein:
the neural network model (24) is configured to classify, based on a sensor signal (108) generated by the at least one measurement sensor (106), the aspirating/dispensing operation into a class of a plurality of classes, the plurality of classes comprising at least one correct class and at least one incorrect class; and
the processor (20) is capable of executing the neural network model (24).

18. The computing device of claim 17, wherein the plurality of classes comprise a first incorrect class indicating an obstructed aspirating/dispensing operation and a second incorrect class indicating an empty aspirating/dispensing operation.

19. The computing device of claim 17 or 18, wherein the neural network model (24) is configured to classify the aspirating/dispensing operation based only on the sensor signal (108).

20. The computing device of any one of claims 17 to 19, wherein the neural network model (24) further comprises an input layer and a noise layer between the input layer (302) and a first convolution block of the plurality of convolution blocks (202-1, 202-2 . . . 202-N).

21. The computing device of any one of claims 17 to 20, wherein the processor is further capable of executing instructions to generate a flag upon classification of the aspirating/dispensing operation in the at least one incorrect class.

22. The computing device of claim 21, wherein the processor is further capable of executing instructions to suspend an analysis process upon generation of the flag.
